(19) United States
(12) Patent Application Publication
(10) Pub. No.: US 2026/0072191 A1
(43) Pub. Date: Mar. 12, 2026

(54) 2D-TO-3D SEISMIC IMAGE CONVERSION USING INTERPOLATION-BASED PROXY MODEL AND A HYBRID WORKFLOW

(71) Applicant: Schlumberger Technology Corporation, Sugar Land, TX (US)

(72) Inventors: Cen Li, Houston, TX (US); Frederico Xavier de Melo, Houston, TX (US); Wenyi Hu, Houston, TX (US); Aria Abubakar, Houston, TX (US); Tao Zhao, Houston, TX (US)

(21) Appl. No.: 19/326,154

(22) Filed: Sep. 11, 2025

Related U.S. Application Data
(60) Provisional application No. 63/693,452, filed on Sep. 11, 2024.
(60) Provisional application No. 63/771,856, filed on Mar. 14, 2025.

(51) Int. Cl. G01V 1/34; G01V 1/30

(52) U.S. Cl. CPC G01V 1/345; G01V 1/302; G01V 1/307

(57) ABSTRACT

The disclosed methods include: generating proxy volume data for a subsurface region of interest at a resource site; pseudo labeling the proxy volume data using at least a high-resolution deterministic interpolation (HRDI) computing process thereby generating labeled volume data for the subsurface region of interest; applying a two-pass deep learning interpolation process to the labeled volume data for the subsurface region of interest along orthogonal directions or orthogonal axes associated with the labeled volume data thereby predicting 3D datapoints for the subsurface region of interest; formatting the 3D datapoints to generate a 3D subsurface image for the subsurface region of interest; and rendering the 3D subsurface image for the subsurface region of interest on a display device, the 3D subsurface image being adaptable for implementing energy development operations.

### CROSS-REFERENCE TO RELATED APPLICATIONS

This application claims priority to and the benefit of U.S. Provisional Patent Application No. 63/693,452, filed Sep. 11, 2024, and U.S. Provisional Patent Application No. 63/771,856, filed Mar. 14, 2025, both of which are hereby incorporated by reference in their entireties.

### INTRODUCTION

The disclosed technology is directed to generating 3-dimensional (3D) subsurface seismic image volumes associated with subsurface structures at a resource site, from 2D seismic measurements.

### BACKGROUND

While using a proxy model can provide a priori information about subsurface structural data of a subsurface under consideration, relying solely on this proxy model for subsurface characterizations has its limitations. For example, some approaches leverage deterministic techniques such as matching-pursuit processes in combination with proxy models to generate 3D seismic volume data. The challenge with such approaches is that not only is it time consuming but it is also computationally intensive and often results in scenarios where blending artifacts become prominent and/or are not eliminated in the generated 3D seismic volume data.

There is a need to minimize and/or eliminate blending artifacts from 3D seismic volume data that are generated using, for example, deterministic approximation techniques.

### SUMMARY

In some aspects, the techniques described herein relate to a method for generating three-dimensional (3D) subsurface image data, including: generating proxy volume data for a subsurface region of interest at a resource site using a low-resolution deterministic interpolation (LRDI) computing process on seismic data associated with the resource site, wherein the proxy volume data includes a 3D subsurface volume indicating structural and amplitude information from two-dimensional seismic lines associated with the subsurface region of interest; pseudo labeling the proxy volume data using a high-resolution deterministic interpolation (HRDI) computing process to generate labeled volume data for the subsurface region of interest; applying a two-pass deep learning interpolation process to the labeled volume data along orthogonal directions to predict 3D datapoints for the subsurface region of interest; and formatting the 3D datapoints to generate a 3D subsurface image for the subsurface region of interest.

In some aspects, the techniques described herein relate to a system for generating three-dimensional (3D) subsurface image data, including: a processor; a memory coupled to the at least one processor; and instructions stored in the memory that, when executed by the processor, cause the system to: generate proxy volume data for a subsurface region of interest at a resource site using a low-resolution deterministic interpolation (LRDI) computing process on seismic data, wherein the proxy volume data indicates structural and amplitude information from two-dimensional seismic lines; perform pseudo labeling of the proxy volume data using a high-resolution deterministic interpolation (HRDI) computing process to generate labeled volume data; apply a two-pass deep learning interpolation process to the labeled volume data along orthogonal directions to predict 3D datapoints; and format the 3D datapoints to generate a 3D subsurface image.

In some aspects, the techniques described herein relate to a non-transitory computer-readable storage medium storing instructions that, when executed by a processor, cause the processor to perform operations including: generating proxy volume data for a subsurface region of interest using a low-resolution deterministic interpolation (LRDI) computing process including selecting N source traces from surrounding two-dimensional seismic lines and merging the source traces using inverse-distance weighted averaging after structural alignment; pseudo labeling the proxy volume data using a high-resolution deterministic interpolation (HRDI) computing process including selecting source traces in a layer-by-layer fashion; applying a two-pass deep learning interpolation process to labeled volume data derived from the pseudo labeling, wherein: a first pass of the two-pass deep learning interpolation process trains a deep learning model along an inline direction using the proxy volume data as input and HRDI results as labels, the first pass generating a first pass prediction; and a second pass two-pass deep learning interpolation process including using the first pass prediction as input with true two-dimensional seismic lines as labels, wherein the second pass predicts 3D datapoints; and generating a 3D subsurface image from the predicted 3D datapoints.

### BRIEF DESCRIPTION OF THE DRAWINGS

The disclosure is illustrated by way of example, and not by way of limitation in the figures of the accompanying drawings in which like reference numerals are used to refer to similar elements. It is emphasized that various features may not be drawn to scale and the dimensions of various features may be arbitrarily increased or reduced for clarity of discussion.

FIG. 1 illustrates an exemplary workflow for generating a target proxy volume.

FIG. 2 depicts a cross-sectional view of a resource site for which the process of FIG. 9 may be executed.

FIG. 3 depicts a networked system illustrating a communicative coupling of devices or systems associated with the resource site of FIG. 7.

FIG. 4 shows an exemplary hybrid data flow associated with generating subsurface volume data using one or more ML engines.

FIG. 5 shows an exemplary workflow for generating 3-dimensional (3D) subsurface image data based on 2-dimensional trace data.

FIG. 6A illustrates an exemplary workflow for generating an input proxy volume.

FIG. 6B shows at least a three-stage computing process for generating output volume data.

FIG. 6C Schematic illustration of the source trace searching process.

FIG. 6D provides an illustration of the interpolation process.

FIGS. 6E and 6F show a comparison between a synthetic-based proxy volume versus an LRDI-based proxy volume/model, respectively.

FIG. 6G shows an exemplary vertical section data of a high-resolution deterministic interpolation (HRDI)-based interpolation result.

FIG. 6H shows a final pseudo-3D result according to some embodiments.

FIG. 6I shows exemplary depth slices of an HRDI-based interpolation result according to some embodiments.

FIG. 6J shows an exemplary final pseudo-3D result according to some embodiments.

FIG. 7 depicts a cross-sectional view of a resource site for which the process of FIG. 9 may be executed.

FIG. 8 depicts a networked system illustrating a communicative coupling of devices or systems associated with the resource site of FIG. 7.

FIG. 9 shows an exemplary hybrid data flow associated with generating subsurface volume data using one or more ML engines.

FIG. 10 shows an exemplary workflow for generating 3D subsurface image data based on 2-dimensional trace data.

FIG. 11 shows an exemplary detailed workflow for methods, systems, and computer programs for generating 3D subsurface image data.

### DETAILED DESCRIPTION

Reference will now be made in detail to embodiments, examples of which are illustrated in the accompanying drawings and figures. In the following detailed description, numerous specific details are set forth in order to provide a thorough understanding of the disclosed subject-matter. However, it will be apparent to one of ordinary skill in the art that the solutions disclosed may be practiced without these specific details. In other instances, well-known methods, procedures, components, circuits, and networks have not been described in detail so as not to unnecessarily obscure aspects of the embodiments.

The disclosed systems and methods may be accomplished using interconnected devices and systems that obtain a plurality of data associated with various parameters of interest at a resource site. The workflows/flowcharts described in this disclosure, according to some embodiments, implicate a new processing approach (e.g., hardware, special purpose processors, and specially programmed general-purpose processors) because such analyses are too complex and cannot be done by a person in the time available or at all. Thus, the described systems and methods are directed to tangible implementations or solutions to specific technological problems in developing natural resources such as oil, gas, water well industries, and other mineral exploration operations. More specifically, the systems and methods presently disclosed may be applicable to operations associated with stratigraphic analysis associated with a resource site.

Attention is now directed to methods, techniques, infrastructure, and workflows for operations that may be carried out at a resource site. Some operations in the processing procedures, methods, techniques, and workflows disclosed herein may be combined while the order of some operations may be changed. Some embodiments include an iterative refinement of one or more data models associated with the resource site via feedback loops executed by one or more computing device processors and/or through other control devices/mechanisms that make determinations regarding whether a given action, template, or resource data, etc., is sufficiently accurate.

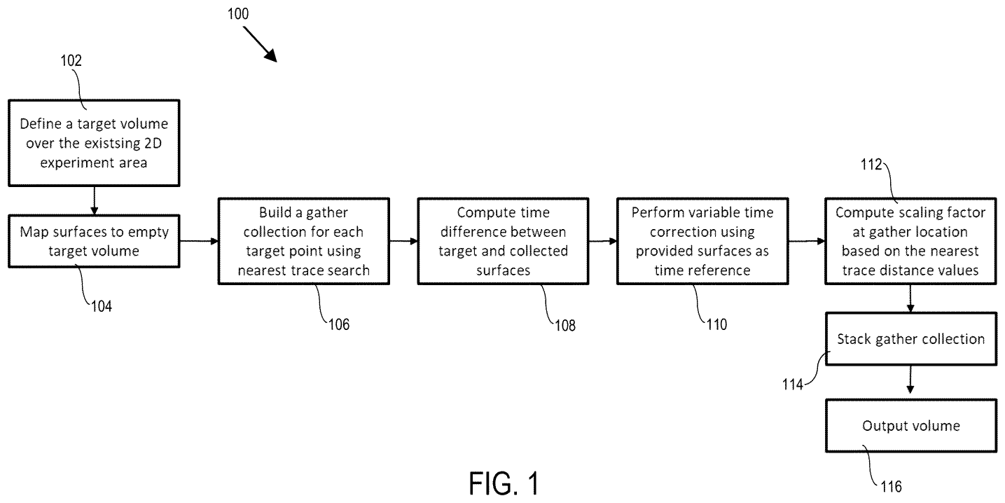

FIGS. 1 through 5 and related descriptions below disclose an exemplary method for generating 3-dimensional (3D) subsurface image data, including example workflows, resource sites, and data flow associated therewith.

### High-Level Workflow

FIG. 1 illustrates an exemplary workflow 100 for generating a target proxy volume. According to one embodiment, the workflow 100 is based on a deterministic nearest-neighbor computing process that leverages data variable correction and data diversity stacking workflows.

At block 102, a target volume over an existing 2D image data of a subsurface associated with a resource site is defined or otherwise determined by a data engine (e.g., a machine learning engine). Turning to block 104, the data engine maps surface data included in the 2D image data to the target volume and thereby generate mapped data. Following this the data engine builds a gather collection for each target point included in the mapped data using a nearest trace search process.

At block 108, the data engine computes, based on the gather collection, a time difference between target data included in the mapped data and collected surface data captured at the resource site. According to one embodiment, the target data is included in, or associated with, the target volume described at block 102.

At block 110, the data engine performs a variable time correction process using provided surfaces configured as time reference data and thereby determine gather location datapoints. Turning to block 112, the data engine can be used to compute a scaling factor at each gather location datapoint based on the nearest trace distance values associated with building the gather collection referenced at block 106, and thereby generate scaled data. Following this, the data engine generates, based on the scaled data, a stack gather collection at block 114. The data engine may be further used to generate an output volume (e.g., 3D volume) as indicated at block 116.

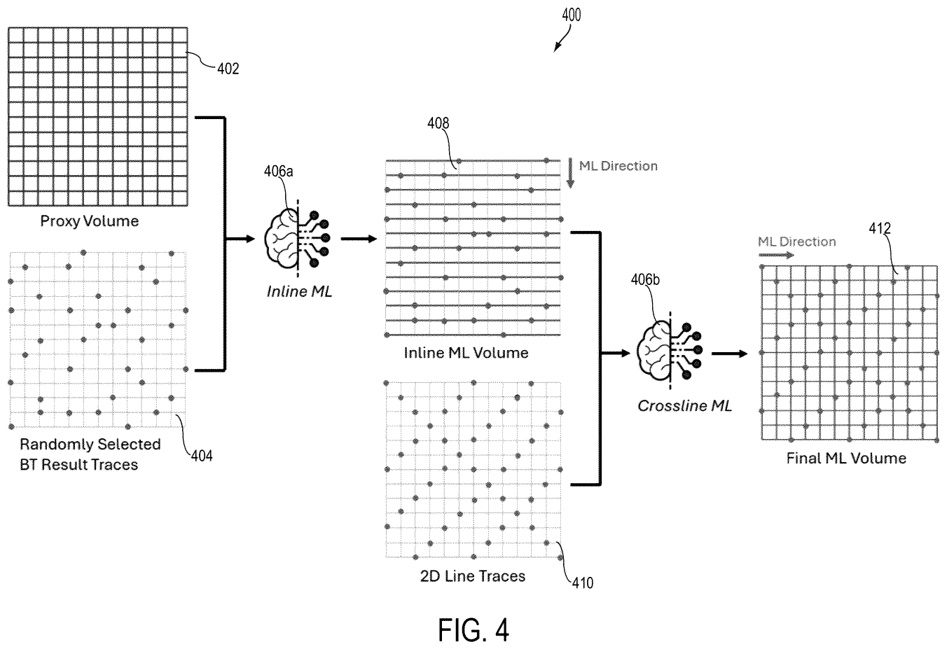

It is appreciated that the workflow of FIG. 1 is associated with a borrowing trace process used or otherwise applied in the workflow of FIG. 4.

### Resource Site

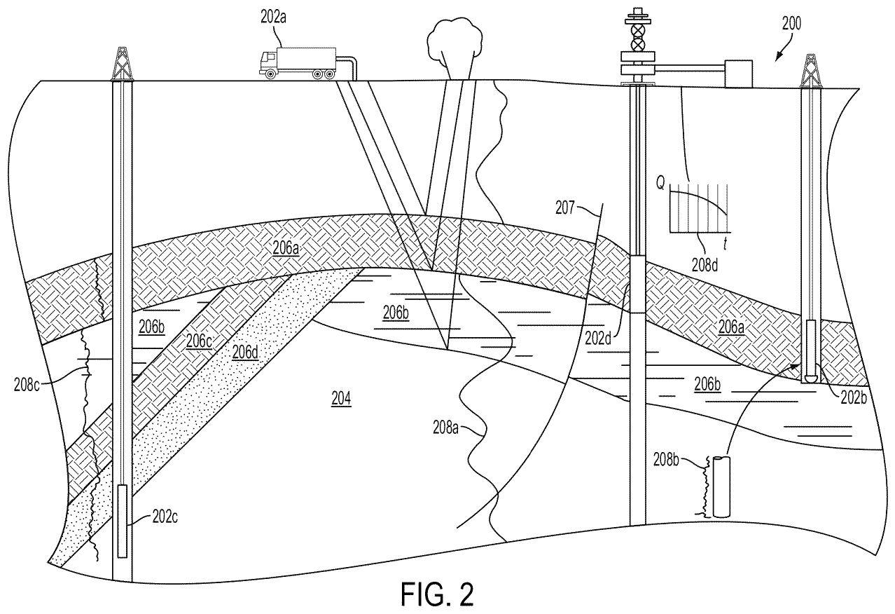

FIG. 2 shows a cross-sectional view of a resource site 200 for which the process of FIG. 1 may be executed. While the illustrated resource site 200 represents a subterranean formation, the resource site, according to some embodiments, may be below water bodies such as oceans, seas, lakes, ponds, wetlands, rivers, or other marine environments.

According to one embodiment, various measurement tools capable of sensing one or more resource site data such as seismic two-way travel time, density, resistivity, production rate, etc., of a subterranean formation and/or geological formations may be provided at the resource site. As an example, wireline tools may be used to obtain measurement information related to geological attributes (e.g., geological attributes of a wellbore and/or reservoir) including geophysical and/or chemical information. For example, the chemical information may include chemical information associated with the subsurface and/or chemical information associated with the surface/above ground areas of the resource site 200.

In some embodiments, various sensors may be located at various locations around the resource site 200 to monitor and collect data and/or core samples for executing the process of FIG. 4.

Part, or all, of the resource site 200 may be on land, on water, or below water. In addition, while a resource site 200 is depicted, the technology described herein may be used with any combination of one or more resource sites (e.g., multiple oil fields or multiple wellsites, one or more saline aquifers, one or more depleted oil/gas fields, etc.), one or more processing facilities, etc. As can be seen in FIG. 2, the resource site 200 may have data acquisition tools 202a, 202b, 202c, and 202d positioned at various locations within the resource site 200. The subterranean structure 204 may have a plurality of geological formations 206a-206d. As shown, this structure may have several formations or layers, including a shale layer 206a, a carbonate layer 206b, a shale layer 206c, and a sand layer 206d. A fault 207 may extend through the shale layer 206a and the carbonate layer 206b. The data acquisition tools, for example, may be adapted to take measurements and detect geophysical and/or chemical characteristics of the various formations shown.

While a specific subterranean formation with specific geological structures is depicted, it is appreciated that the resource site 200 may contain a variety of geological structures and/or formations, sometimes having extreme complexity. In some locations of a given geological structure, for example below a water line (e.g., aquifer) relative to the given geological structure, fluid may occupy pore spaces of the formations. Each of the measurement devices may be used to measure properties of the formations and/or other geological features. While each data acquisition tool is shown as being in specific locations in FIG. 2, it is appreciated that one or more types of measurement may be taken at one or more locations across one or more sources of the resource site 200 or other locations for comparison and/or analysis.

The data collected from various sources at the resource site 200 may be processed and/or evaluated and/or used as training data, and or used to generate high resolution result sets for characterizing a resource at the resource site, and/or used for generating resource models, etc. In one embodiment, the core sample data and/or data collected by a set of sensors at the resource site may include data associated with the number of wells of a first reservoir or second reservoir at the resource site, data associated with the number of grid cells of the first or second reservoir, data associated with the average permeability of the first or second reservoir, data associated with the production duration history (e.g., number of years of production) of the first reservoir or second, etc.

Data acquisition tool 202a is illustrated as a measurement truck, which may include devices or sensors that take measurements of the subsurface through sound vibrations such as, but not limited to, seismic measurements. Drilling tool 202b may include a downhole sensor adapted to perform logging while drilling (LWD) data collection. The wireline tool 202c may include a downhole sensor deployed in a wellbore or borehole. Production tool 202d may be deployed from a production unit or Christmas tree into a completed wellbore. Examples of resource site data that may be measured include weight on bit, torque on bit, subterranean pressures (e.g., underground fluid pressure), temperatures, flow rates, compositions, rotary speed, particle count, voltages, currents, and/or other parameters of operations as further discussed below.

Sensors may be positioned about the resource site to collect data relating to various resource site operations, such as sensors deployed by the data acquisition tools 202. The sensor may include any type of sensor such as a metrology sensor (e.g., temperature, humidity), an automation enabling sensor, an operational sensor (e.g., pressure sensor, H₂S sensor, thermometer, depth, tension), evaluation sensors, which can be used for acquiring data regarding the formation, wellbore, formation fluid/gas, wellbore fluid, gas/oil/water included in the formation/wellbore fluid, or any other suitable sensor. For example, the sensors may include accelerometers, flow rate sensors, pressure transducers, electromagnetic sensors, acoustic sensors, temperature sensors, chemical agent detection sensors, nuclear sensor, and/or any additional suitable sensors.

In one embodiment, the data captured by the one or sensors may be used to characterize, or otherwise generate one or more parameter values for a high-resolution result set used to, for example, label or configure a machine learning (ML) engine, a resource model as the case may require. In other embodiments, test data or synthetic data may also be used in developing the ML engine or resource model (e.g., a subsurface model) via one or more parameterization/labeling operations such as those discussed in association with FIG. 4.

Evaluation sensors may be featured in downhole tools such as tools 202b-202d and may include for instance electromagnetic, acoustic, nuclear, and optic sensors. Examples of tools including evaluation sensors that can be used in the framework of the current method include electromagnetic tools including imaging sensors such as FMI™ or QuantaGeo™ (mark of SLB, Houston, TX); induction sensors such as Rt Scanner™ (mark of SLB, Houston, TX), multifrequency dielectric dispersion sensor such as Dielectric Scanner™ (mark of SLB, Houston, TX); acoustic tools including sonic sensors, such as Sonic Scanner™ (mark of SLB, Houston, TX) or ultrasonic sensors, such as pulse-echo sensor as in UBI™ or PowerEcho™ (marks of SLB, Houston, TX) or flexural sensors PowerFlex™ (mark of SLB, Houston, TX); nuclear sensors such as Litho Scanner™ (mark of SLB, Houston, TX) or nuclear magnetic resonance sensors; fluid sampling tools including fluid analysis sensors such as InSitu Fluid Analyzer™ (mark of SLB, Houston, TX); distributed sensors including fiber optic. Such evaluation sensors may be used in particular for evaluating the formation in which the well is formed (i.e., determining petrophysical or geological properties of the formation), for verifying the integrity of the well (such as casing or cement properties) and/or analyzing the produced fluid (flow, type of fluid, etc.).

As shown, data acquisition tools 202a-202d may generate data plots or measurements 208a-208d, respectively. These data plots are depicted within the resource site 200 to demonstrate that data generated by some of the operations executed at the resource site 200.

Data plots 208a-208c are examples of static data plots that may be generated by data acquisition tools 202a-202c, respectively. However, it is herein contemplated that data plots 208a-208c may also be data plots that may be generated and updated in real time. These measurements may be analyzed to better define properties of the formation(s) and/or determine the accuracy of the measurements and/or check for and compensate for measurement errors. The plots of each of the respective measurements may be aligned and/or scaled for comparison and verification purposes. In some embodiments, base data associated with the plots may be incorporated into site planning, modeling a test at the resource site 200. The respective measurements that can be taken may be any of the above.

Other data may also be collected, such as historical data of the resource site 200 and/or sites similar to the resource site 200, user inputs, information (e.g., economic information) associated with the resource site 200 and/or sites similar to the resource site 200, and/or other measurement data and other parameters of interest. Similar measurements may also be used to measure changes in formation aspects over time.

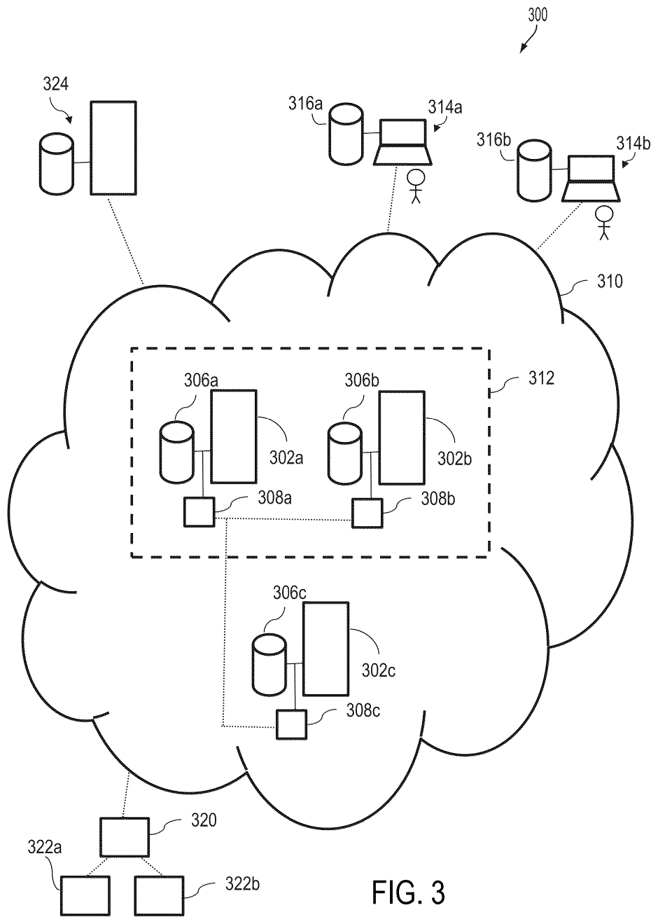

Computer facilities such as those discussed in association with FIG. 3 may be positioned at various locations about the resource site 200 (e.g., a surface unit) and/or at remote locations. A surface unit (e.g., one or more terminals 320) may be used to communicate with the onsite tools and/or offsite operations, as well as with other surface or downhole sensors. The surface unit may be capable of sending commands to the oil field equipment/systems, and receiving data therefrom. The surface unit may also collect data generated during production operations and can produce output data, which may be stored or transmitted for further processing.

The data collected by sensors may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis or for modeling purposes to optimize production processes at the resource site 200. In one embodiment, the data is stored in separate databases, or combined into a single database.

### Network System

FIG. 3 shows a high-level networked system diagram 300 illustrating a communicative coupling of devices or systems associated with the resource site 200 as described in FIG. 2. The system shown in the figure may include a set of processors 302a, 302b, and 302c for executing one or more processes discussed herein. The set of processors 302 may be electrically coupled to one or more servers (e.g., computing systems) including memory 306a, 306b, and 306c that may store for example, program data, databases, and other forms of data. Each server of the one or more servers may also include one or more communication devices 308a, 308b, and 308c. The set of servers may provide a cloud-computing platform 310. In one embodiment, the set of servers includes different computing devices that are situated in different locations and may be scalable based on the needs and workflows associated with the resource site 200. The communication devices of each server may enable the servers to communicate with each other through a local or global network such as an Internet network. In some embodiments, the servers may be arranged as a town 312, which may provide a private or local cloud service for users. A town may be advantageous in remote locations with poor connectivity. Additionally, a town may be beneficial in scenarios with large networks where security may be of concern. A town in such large network embodiments can facilitate implementation of a private network within such large networks. The town may interface with other towns or a larger cloud network, which may also communicate over public communication links. Note that cloud-computing platform 310 may include a private network and/or portions of public networks. In some cases, a cloud-computing platform 310 may include remote storage and/or other application processing capabilities.

The system of FIG. 3 may also include one or more user terminals 314a and 314b each including at least a processor to execute programs, a memory (e.g., 316a and 316b) for storing data, a communication device and one or more user interfaces and devices that enable the user to receive, view, and transmit information. In one embodiment, the user terminals 314a and 314b is a computing system having interfaces and devices including keyboards, touchscreens, display screens, speakers, microphones, a mouse, styluses, etc. The user terminals 314 may be communicatively coupled to the one or more servers of the cloud-computing platform 310. The user terminals 314 may be client terminals or expert terminals, enabling collaboration between clients and experts through the system of FIG. 3.

The system of FIG. 3 may also include at least one or more resource sites 200 having, for example, a set of terminals 320, each including at least a processor, a memory, and a communication device for communicating with other devices communicatively coupled to the cloud-computing platform 310. The resource site 200 may also have a set of sensors (e.g., one or more sensors described in association with FIG. 2) or sensor interfaces 322a and 322b communicatively coupled to the set of terminals 320 and/or directly coupled to the cloud-computing platform 310. In some embodiments, data collected by the set of sensors/sensor interfaces 322a and 322b may be processed to generate a one or more resource models (e.g., reservoir models) or one or more resolved data sets used to generate the resource model which may be displayed on a user interface associated with the set of terminals 320, and/or displayed on user interfaces associated with the set of servers of the cloud computing platform 310, and/or displayed on user interfaces of the user terminals 314. Furthermore, various equipment/devices discussed in association with the resource site 200 may also be communicatively coupled to the set of terminals 320 and or communicatively coupled directly to the cloud-computing platform 310. The equipment and sensors may also include one or more communication device(s) that may communicate with the set of terminals 320 to receive orders/instructions locally and/or remotely from the resource site 200 and also send statuses/updates to other terminals such as the user terminals 314.

The system of FIG. 3 may also include one or more client servers 324 including a processor, memory, and communication device. For communication purposes, the client servers 324 may be communicatively coupled to the cloud-computing platform 310, and/or to the user terminals 314a and 314b, and/or to the set of terminals 320 at the resource site 200 and/or to sensors at the oil field, and/or to other equipment at the resource site 200.

A processor, as discussed with reference to the system of FIG. 3, may include a microprocessor, a graphical processing unit (GPU), a microcontroller, a processor module or subsystem, a programmable integrated circuit, a programmable gate array, or another control or computing device.

The memory/storage media discussed above in association with FIG. 3 can be implemented as one or more computer-readable or machine-readable storage media that are non-transitory. In some embodiments, storage media may be distributed within and/or across multiple internal and/or external enclosures of a computing system and/or additional computing systems. Storage media may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs), BluRays or any other type of optical media; or other types of storage devices. “Non-transitory” computer readable medium refers to the medium itself (i.e., tangible, not a signal) and not data storage persistency (e.g., RAM vs. ROM).

Note that instructions can be provided on one computer-readable or machine-readable storage medium, or alternatively, can be provided on multiple computer-readable or machine-readable storage media distributed in a large system having possibly plural nodes and/or non-transitory storage means. Such computer-readable or machine-readable storage medium or media is (are) considered to be part of an article (or article of manufacture). The storage medium or media can be located either in a computer system running the machine-readable instructions, or located at a remote site from which machine-readable instructions can be downloaded over a network for execution.

It is appreciated that the described system of FIG. 3 is an example that may have more or fewer components than shown, may combine additional components, and/or may have a different configuration or arrangement of the components. The various components shown may be implemented in hardware, software, or a combination of both, hardware, and software, including one or more data processing and/or application specific integrated circuits.

Further, the steps in FIG. 4 described below may be implemented by running one or more functional modules in an information processing apparatus such as general-purpose processors or application specific chips, such as ASICs, FPGAs, PLDs, GPUs or other appropriate devices associated with the system of FIG. 3. For example, the flowchart of FIG. 4 below may be executed using a data engine or a data processing module (e.g., computing module) stored in memory 306a, 306b, or 306c such that the data engine/data processing module includes instructions that are executed by the one or more processors such as processors 302a, 302b, or 302c as the case may be. The various modules of FIG. 3, combinations of these modules, and/or their combination with general hardware are included within the scope of protection of the disclosure. While one or more computing processors (e.g., processors 302a, 302b, or 302c) may be described as executing steps associated with, for example, FIG. 4, the one or more computing device processors may be associated with the cloud-based computing platform 310 and may be located at one location or distributed across multiple locations. In one embodiment, the one or more computing device processors may also be associated with other systems of FIG. 3 other than the cloud-computing platform 310.

In some embodiments, a computing system is provided that includes at least one processor, at least one memory, and one or more programs stored in the at least one memory, such that the programs include instructions, which when executed by the at least one processor, are configured to perform any method disclosed herein.

In some embodiments, a computer readable storage medium is provided, which has stored therein one or more programs, the one or more programs including instructions, which when executed by a processor, cause the processor to perform any method disclosed herein. In some embodiments, a computing system is provided that includes at least one processor, at least one memory, and one or more programs stored in the at least one memory for performing any method disclosed herein. In some embodiments, an information processing apparatus for use in a computing system is provided for performing any method disclosed herein.

### Embodiments

This disclosure is directed to reconstructing 3-dimensional (3D) subsurface image volumes based on two-dimensional (2D) image measurements (e.g., seismic image measurements). According to one embodiment, a machine learning (ML) engine is used to construct a subsurface model indicating a 3D seismic volume based on 2D seismic lines. In particular, a proxy model indicating subsurface structural information of a subsurface region of interest may be provided as initial basis data or seed data for the ML engine. This proxy model can provide a priori information about subsurface structural data of a subsurface under consideration such that the a priori information of the subsurface is incorporated by the ML engine to automatically and directly train a subsurface model.

According to one embodiment, the disclosed method employs a multi-directional label-free learning strategy to enforce data coherence of the generated 3D volume in an efficient manner, resulting in a reliable subsurface structural reconstruction based on the subsurface model without suffering dimensionality data problems. In addition, the disclosed systems leverage a hybrid technique that jointly applies a deterministic and/or non-deterministic method associated with a proxy-based ML process. Whenever applicable, this hybrid approach can provide better resolution and clarity by incorporating inherent features from recorded data that is projected at randomly selected locations about a subsurface region of interest.

In some implementations, the ML engine creates a 3D volume using 2D seismic lines based on a deterministic process including a pseudo-gather construction technique. In particular, this construction technique may be based on applying a borrowing-nearest-neighbor search and vertical dynamic position correction process (e.g., a borrowing trace (BT) process) to the 2D seismic lines. In such a process, each subsurface location of interest is diversity summed based on a differential inverse distance between a desired location and collected locations (e.g., subsurface locations of interest) relative to each 2D seismic line. In some instances, the 2D seismic line is limited by a defined maximum acceptance distance, thereby resulting in a BT 3D volume that effectively preserves 2D resolution data associated with the 2D seismic lines. According to some embodiments, the generated BT 3D volume lacks blending artifacts that are removed or otherwise minimized or eliminated using the disclosed hybrid process. It is appreciated that the borrowing trace process uses 2D seismic images to construct a 3D seismic volume that may have blending artifacts. Because of these blending artifacts, the 3D seismic volume generated may require further computational editing or revisions prior to generating the final 3D seismic volume. It is appreciated that the ML engine beneficially facilitates removing the blending artifacts in the BT created volume. To do so, a small portion of BT generated traces associated with the BT volume is used to augment training of the subsurface model by the ML engine resulting in a first ML trained subsurface model. The ML trained subsurface model (e.g., 3D seismic volume) is much cleaner than the original BT created volume. In particular, the BT created volume creates the initial version of the subsurface volume, which is then used by ML engine to create the improved final version of the volume (e.g., the ML trained volume).

As part of generating the final version of the 3D seismic volume, a small set of traces in the BT created volume is randomly selected to augment a proxy model associated with a subsurface region of interest. For example, 2-3% of BT volume traces may be used for such augmentations. These traces can facilitate model reinforcements that bridge big gaps between sparse 2D seismic lines. In particular, the disclosed ML engine is configured to generate a plurality of content data based on the disclosed proxy volume. Thus, the disclosed proxy-based ML process can effectively suppress blending artifacts in BT results because it beneficially maintains signals that are more aligned with the disclosed proxy volume thereby ensuring that said signals are preserved and propagated into the final output volume (e.g., 3D volume) that is generated using the disclosed techniques.

FIG. 4 shows an exemplary hybrid data flow 400 associated with generating subsurface volume data using one or more ML engines. As can be seen in the figure, the ML engine 406a may receive proxy volume data 402 associated with a subsurface at a resource site as well as randomly selected borrowing trace (BT) result traces 404. According to one embodiment, a plurality of BT traces may be generated for the proxy volume data 402 such that the BT result traces 404 are selected from the plurality of BT traces generated for the proxy volume data 402. It is appreciated that the proxy volume data 402 can be generated using legacy data associated with a subsurface of interest at the resource site and/or synthetically generated data associated with the subsurface of interest at the resource site.

According to one embodiment, the randomly selected BT result traces 404 can be automatically determined for the proxy volume data 402 using, for example, data approximation techniques or data computations based the proxy model using a BT process. It is appreciated that the BT traces indicate vertical datapoint approximations of a plurality of vertical locations projected, based on the proxy volume data 402, from a surface location of the region of interest to a subsurface location within the region of interest for the subsurface of the resource site. For example, the vertical locations may represent an inline direction or a downward approximation of vertical locations in the subsurface that are directionally and/or agnostically and/or randomly selected for the region of interest within the subsurface of the resource site associated with the proxy volume data 402. According to one embodiment, the randomly selected BT result traces 404 may be based on the proxy volume data 402 such that the proxy volume data may be determined based on: legacy data associated with the region of interest at the resource site; a first set or a second set of sensor measurements (e.g., well log measurements) associated with the region of interest; horizon interpretation data associated with a first region at the resource site; horizon interpretation data associated with a second region at the resource site or a third region different from the first region and second region at the resource site or from another resource site such that the proxy volume data 402 is substantially similar to, or minimally distinct from the proxy volume data of the second region or third region.

At a first stage of the hybrid data flow, the ML engine 406a may generate an inline ML volume based on applying, in an inline direction (e.g., vertical direction), the randomly selected BT result traces 404 to the proxy volume data 402 and thereby generate first subsurface volume data 408 (e.g., inline volume). In particular, the first subsurface volume data 408 indicates an impact of interacting the randomly selected BT result traces 404 to the proxy volume data 402.

The second ML stage includes leveraging the same ML engine 406a and/or a different ML engine 406b to process the first subsurface volume data 408 in a crossline or horizontal direction based on 2D trace data 410 (e.g., derived from sensor measurements for one or more regions of interest at the resource site associated with the proxy volume data 402. In particular, the first or second ML engines 406a and 406b may apply the 2D line trace data 410 to the first subsurface volume data 408 in the crossline direction (e.g., horizontal direction) and thereby generate the second subsurface volume data 412. In some cases, the second subsurface volume data 412 indicates a final seismic image of the subsurface of the resource with no blending artifacts included therein, or little to no blending artifacts included therein.

According to one embodiment, the 2D trace data 410 may be based on actual sensor measurements (e.g., well log measurements) from a plurality of sensors (e.g., seismic sensors) that sparsely located (e.g., between 1 km-2 km, or between 1 km-3 km, or between 1 km-4 km, or between 1 km-5 km) relative to each other in a geometrically determined regional grid (e.g., square grid, circular grid, rectangular grid, triangular grid, or a combination of regional grids) included in, or associated with the proxy volume data 402. According to some embodiments, the 2D trace data may include data derived from sensor measurements (e.g., seismic sensor measurements) synchronously or asynchronously acquired using: a first set of sparsely spaced (e.g., between 1 km-2 km, or between 1 km-3 km, or between 1 km-4 km, or between 1 km-5 km) sensors deployed at a first region of interest at the resource site at a first time; and/or a second set of sparsely spaced sensors deployed at a second region of interest at the resource site at a second time; and/or a third set of sparsely spaced sensors deployed at a third region of interest at the resource site at a third time; and/or a fourth set of sparsely spaced sensors deployed at a third region of interest at the resource site at a fourth time.

In other embodiments, a plurality of 2D trace data 410 may be dynamically applied to the first subsurface volume data 408 to generate the second subsurface volume data 412 and thereby minimize or eliminate blending artifacts that distort or otherwise corrupt the second subsurface volume data 412. According to one embodiment, the second subsurface volume data 412 can be beneficially indicate: upstream domain data associated with exploring and producing energy; midstream domain data associated with transporting and storing energy; and downstream domain data associated with refining energy. In particular, the data included in the second subsurface volume data 412 can be advantageously used for equipment placement operations at the resource site by determining optimal locations, based on subsurface structures, to place energy extraction equipment such as pumps (e.g., oil or gas pumps), conveyor systems (e.g., tubings or piping, etc.) to place at the resource site. Also, the second subsurface volume data 412 can facilitate surgically determining a subsurface resource at the resource site.

It is appreciated that the disclosed process beneficially enables the use of 2D sensor measurements (e.g., 2D trace data 410) derived from substantially sparse sensors (e.g., seismic sensors, wellbore sensors, etc.) to generate 3D volume data of a subsurface based on proxy volume data. This beneficially leverages image data of a lower dimension (e.g., 2D trace data) in combination with a determined proxy volume to generate image data of a higher dimension (e.g., 3D volume data or the subsurface volume data 408 referenced above).

### Detailed Workflow

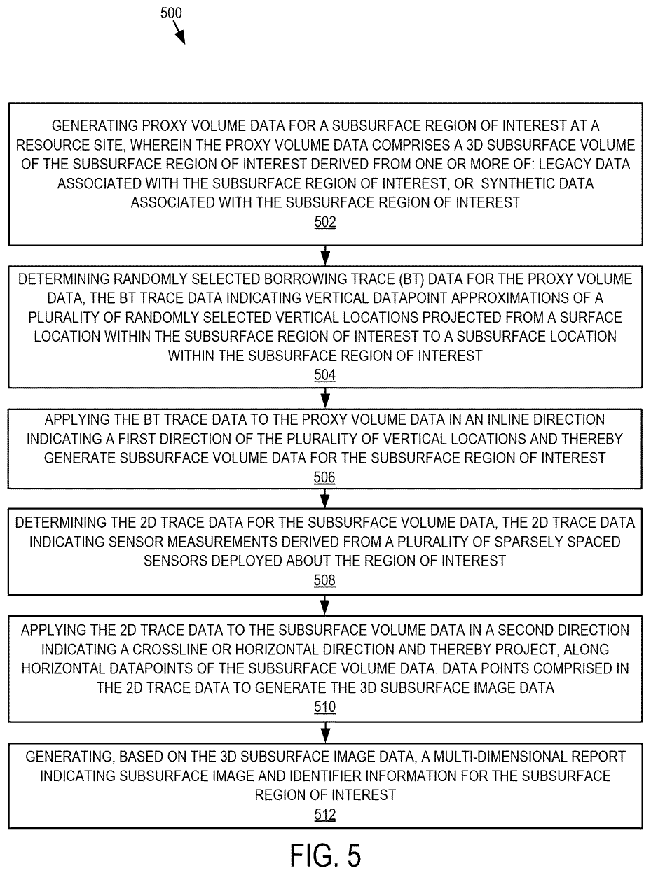

FIG. 5 shows an exemplary workflow 500 for generating 3-dimensional (3D) subsurface image data based on 2-dimensional trace data. It is appreciated that a data engine stored in a memory device may cause a computer processor to execute the various stages of the workflow 500. For example, the disclosed techniques may be implemented as a data engine of a computing platform associated with a geological software tool such that the data engine enables optimally generating 3-dimensional (3D) subsurface image data based on 2-dimensional trace data.

At block 502, the data engine may generate proxy volume data for a subsurface region of interest at a resource site. According to one embodiment, the proxy volume data includes a 3D subsurface volume of the subsurface region of interest derived from one or more of: legacy data associated with the subsurface region of interest, or synthetic data associated with the subsurface region of interest.

Turning to block 504, the data engine determines randomly selected borrowing trace (BT) data for the proxy volume data. The BT trace data can indicate vertical datapoint approximations of a plurality of randomly selected vertical locations projected from a surface location within the subsurface region of interest to a subsurface location within the subsurface region of interest.

At block 506, the data engine applies the BT trace data to the proxy volume data in an inline direction indicating a first direction of the plurality of vertical locations and thereby generate subsurface volume data for the subsurface region of interest.

At block 508, the data engine determines the 2D trace data for the subsurface volume data. For example, the 2D trace data can indicate sensor measurements derived from a plurality of sparsely spaced sensors deployed about the region of interest.

At block 510, the data engine applies the 2D trace data to the subsurface volume data in a second direction and thereby project, along horizontal datapoints of the subsurface volume data, data points included in the 2D trace data to generate the 3D subsurface image data.

Moving on to block 512, the data engine generates, based on the 3D subsurface image data, a multi-dimensional report indicating subsurface image and identifier information for the subsurface region of interest.

In other embodiments, a system and a computer program can include or execute the method described above. These and other implementations may each optionally include one or more of the following features.

Applying the 2D trace data to the subsurface volume data minimizes or eliminates blending artifacts included int the 2D trace data.

In some cases, the plurality of sparsely spaced sensors include seismic imaging sensors that capture 2-dimensional seismic images of the subsurface region of interest.

Moreover, the plurality of sparsely spaced sensors are spaced from each other by one of: about 1 km-2 km, or about 1 km-3 km, or about 1 km-4 km, or about 1 km-5 km.

According to some embodiments, a machine learning engine: applies the BT trace data to the proxy volume data in the inline direction, and applies the 2D trace data to the subsurface volume data in the crossline direction.

In addition, the machine learning engine referenced above can train a subsurface model associated with the resource site based on at least applying the BT trace data to the proxy volume data in an inline direction. This subsurface model can then be used in imaging applications associated with the subsurface of interest associated with the resource site or other subsurfaces that are similar to or distinct from the subsurface of interest referenced above in association with the resource site.

In some embodiments, the machine learning engine uses a convolutional neural network in training the subsurface model. In other embodiments, the machine learning uses a recurrent neural network and/or a deep neural network.

In some cases, the proxy volume data indicates a priori information about the subsurface region of interest.

In some embodiments, the BT data is derived from diversity summing, based on an inverse distance between a first set of subsurface locations associated with the proxy volume data relative to datapoints included in the 2D trace data.

According to some implementations, the report drives one or more energy development operations at the resource site.

It is appreciated that the BT data is generated based on a deterministic interpolation process. In one embodiment, the deterministic interpolation process is applied to the proxy volume to generate the subsurface volume data referenced above.

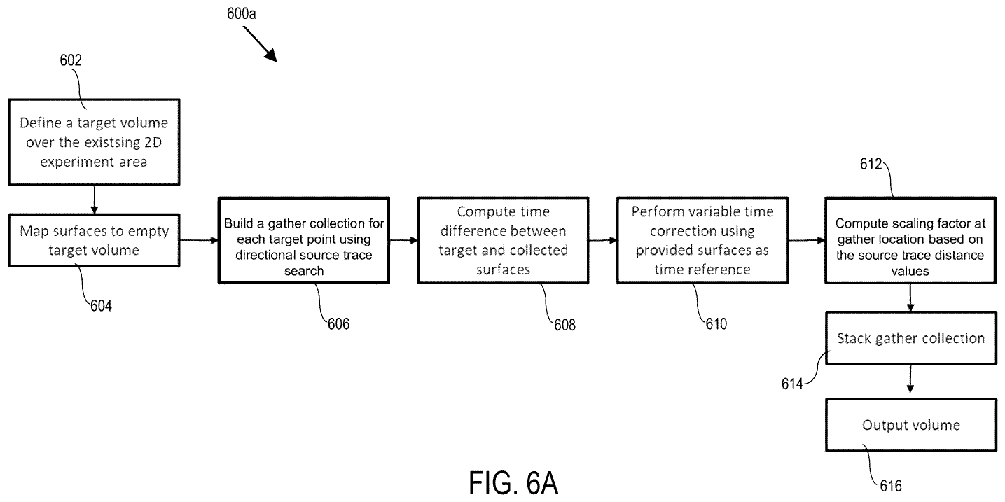

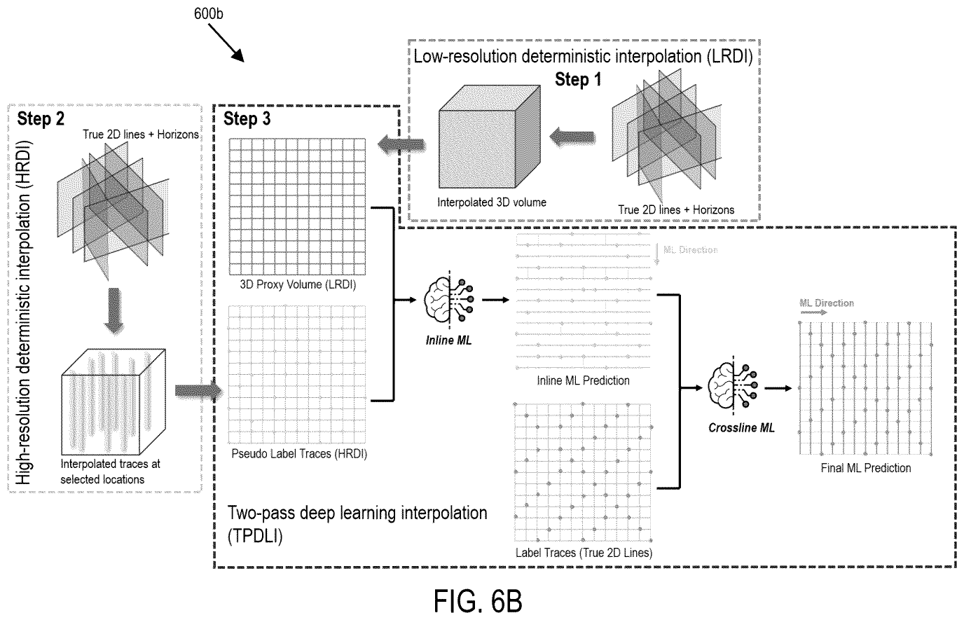

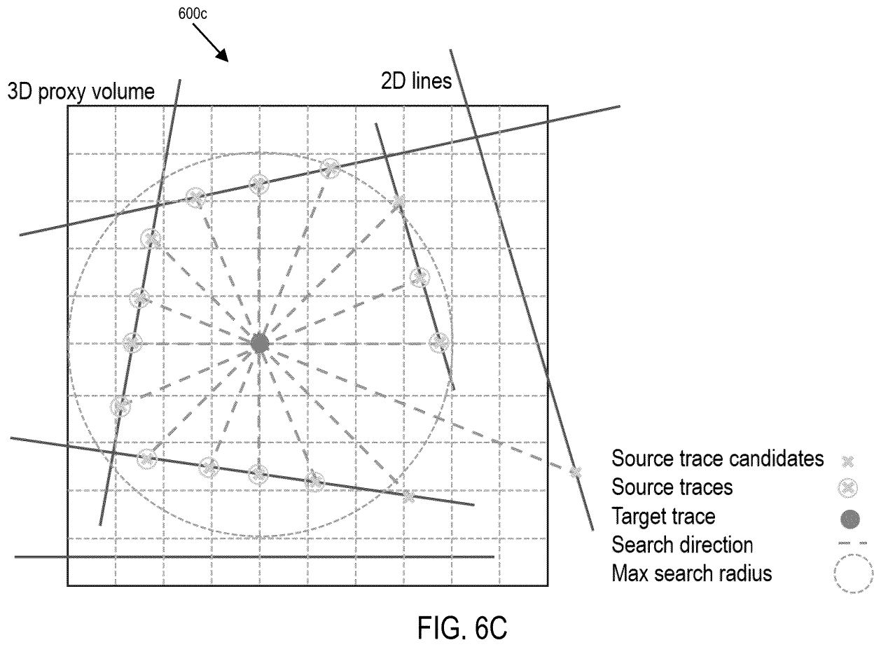

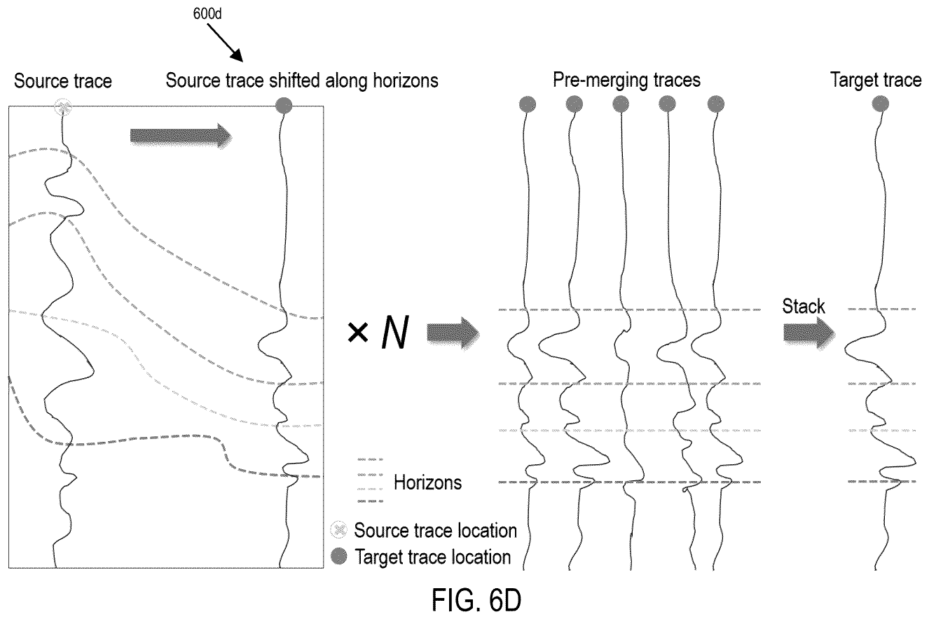

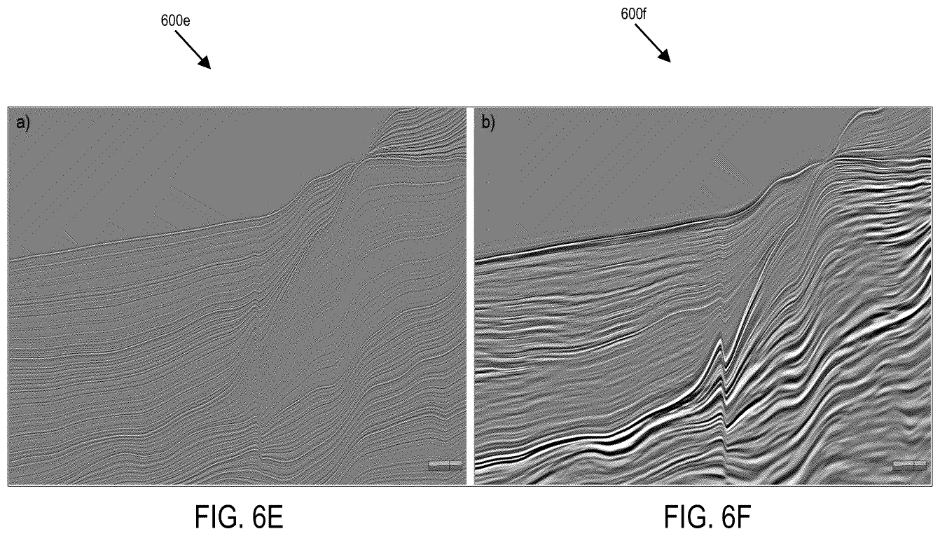

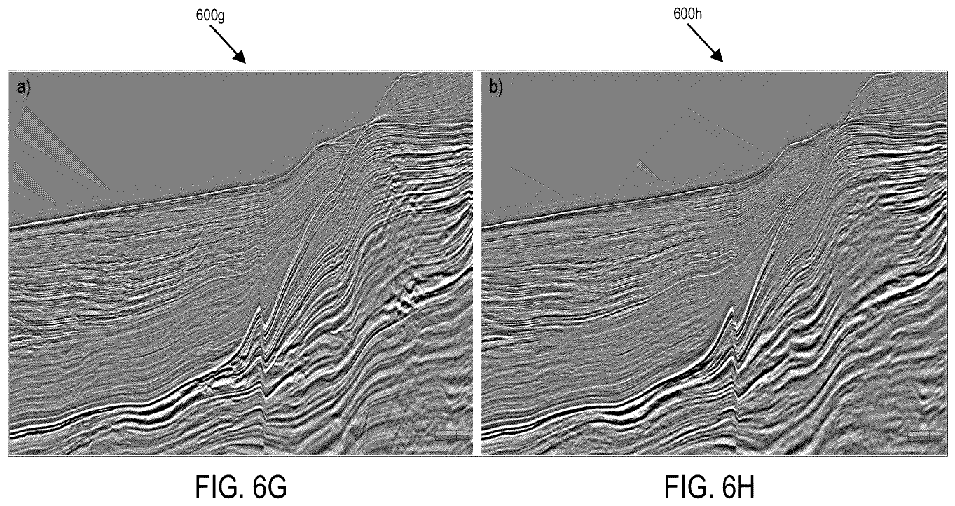

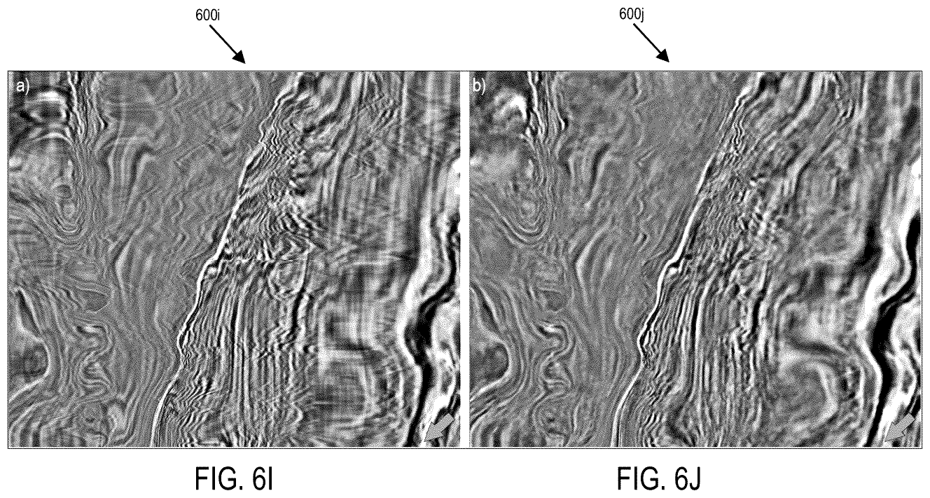

FIGS. 6A through 11 and related descriptions below disclose an exemplary method for generating 3-dimensional (3D) subsurface image data, including example workflows, computing processes, results, devices, resource sites, and data flow associated therewith.

### Overview

FIG. 6A illustrates an exemplary workflow 600a for generating an input proxy volume. According to one embodiment, the workflow 600 is based on a deterministic computing process that leverages directional search, data variable correction, and data diversity stacking workflows.

At block 602, a target volume over an existing 2D image data of a subsurface associated with a resource site is defined or otherwise determined by a data engine (e.g., a machine learning engine). Turning to block 604, the data engine maps surface data included in the 2D image data to the target volume and thereby generate mapped data. Following this the data engine builds a gather collection for each target point included in the mapped data using a directional source trace search process.

At block 608, the data engine computes, based on the gather collection, a time difference between target data included in the mapped data and collected surface data captured at the resource site. According to one embodiment, the target data is included in, or associated with, the target volume described at block 602.

At block 610, the data engine performs a variable time correction process using provided surfaces configured as time reference data and thereby determine gather location datapoints. Turning to block 612, the data engine can be used to compute a scaling factor at each gather location datapoint based on the source trace distance values associated with building the gather collection referenced at block 606, and thereby generate scaled data. Following this, the data engine generates, based on the scaled data, a stack gather collection at block 614. The data engine may be further used to generate an output volume (e.g., 3D volume) as indicated at block 616.

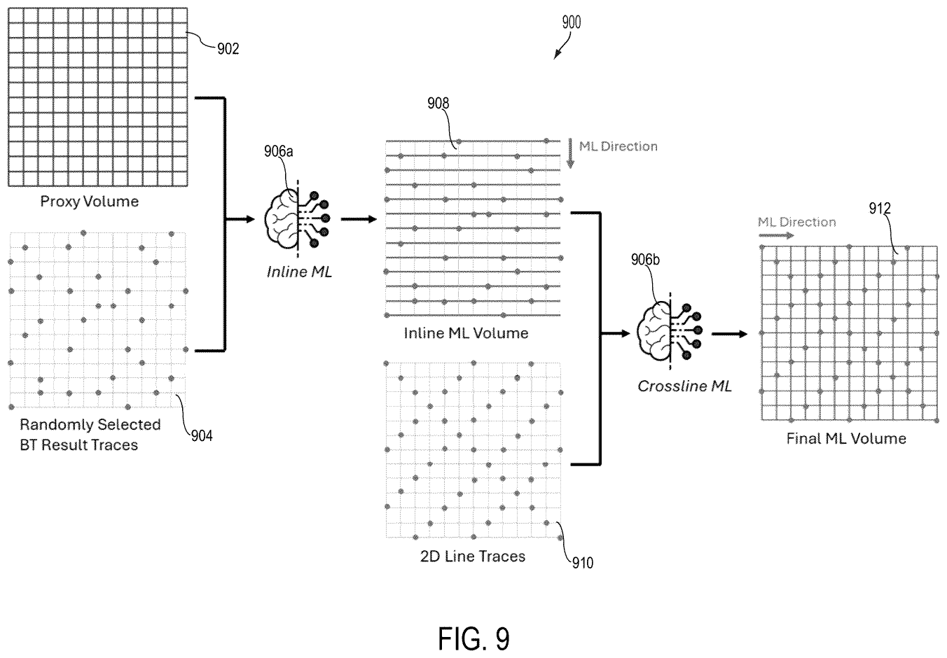

It is appreciated that the workflow of FIG. 6A or 6B is associated with a borrowing trace process used or otherwise applied in the workflow of FIG. 9.

According to some embodiments, this disclosure is also directed to a workflow designed to solve a 2D-to-3D seismic image conversion problem. In particular, this disclosure provides a process for generating a proxy model that is used in a workflow for 2D-to-3D image conversion. According to one embodiment, the generated 3D image advantageously provides a resolved or otherwise improved resolution of image data associated with subsurface structures.

In some implementations, the disclosed methods and systems enable building or developing 3D seismic image volumes from 2D seismic data. Specifically, the proposed workflow provides significantly improved result quality based on the workflow steps associated with FIG. 6B. In particular, FIG. 6B shows at least a three stage computing process 600b including: a proxy volume generation process via low-resolution deterministic interpolation (LRDI) computing operation; a pseudo label generation process via high-resolution deterministic interpolation (HRDI) computing operation; and a two-pass deep learning interpolation (TPDLI) process. These three processing stages or steps are as follows:

### Step 1

According to one embodiment, the proxy volume generation process is achieved using a low-resolution deterministic interpolation (LRDI) computing operation. This can include using a computing approach that builds the proxy model. Unlike synthetic-based approaches, the disclosed proxy model can be constructed based on real 2D seismic data using the aforementioned LRDI computing operation.

One objective of step 1 is to prepare input data (e.g., seismic data) for a deep learning (DL)-based TPDLI computing operation, which can be referred to as a proxy volume computing operation. It is appreciated that a proxy volume (e.g., subsurface image data indicating volumetric subsurface structures) can be generated based on a synthetic seismic image volume derived from convolving a randomly generated 3D reflectivity model with a statistical wavelet, with the structure of the reflectivity model being defined by interpreted seismic horizons data. Although such proxy volume shares similar structural information as 2D seismic data, amplitude information associated with said proxy volumes can be very different, which can negatively affect the final interpolation result. As such the disclosed methods and systems provide a structurally guided interpolation scheme for generating a proxy volume that honors or otherwise factors in both structural and amplitude information from true or accurate 2D seismic data lines.

For each interpolation target trace location, N source traces can be selected from surrounding 2D lines, which are first structurally aligned using structural information obtained from the 2D lines, before merging into one trace via inverse-distance weighted average. The structural information can be represented in different forms, including but not limited to interpreted seismic horizons from either manual or automatic workflows, structural seismic attributes such as dip or relative geologic time, and geocellular structural models. In particular, interpreted seismic horizons data can be used to represent structural information associated with subsurface structures. FIG. 6C provides an illustration 600c of a source trace searching process with N being equal to 16. In particular, FIG. 6C shows a schematic illustration of the disclosed source trace searching process. In one embodiment, the searching process of FIG. 6C is associated with, or included in the interpolation process of FIG. 6D. In this example, there are maximum of 16 source traces with the final selected sources traces being limited to within a specific search radius.

FIG. 6D provides an illustration 600d of the interpolation process (e.g., LRDI computing operation). In particular, this figure shows a schematic illustration of the interpolation process such that for each target trace location, N source traces from 2D lines can be shifted along horizons before merging into a single trace using inverse distance weighting. To further improve the lateral continuity of the proxy volume, aggressive structural-guided smoothing computing operations may be applied to the interpolation result.

FIGS. 6E and 6F show a comparison between a synthetic-based proxy volume 600e (e.g., FIG. 6E) versus an LRDI-based proxy volume/model 600f (e.g., FIG. 6F). As seen in FIG. 6F, the LRDI-based proxy model provides a more natural look than the synthetic model, while is also smooth enough to be used as AN initial base model that can be inputted to the DL.

### Step 2

At this stage, a pseudo label generation process based on an HRDI computing operation is applied to the generated proxy model. According to some embodiments, this step can be mapped to a deterministic borrow trace (BT) process if needed. It is appreciated that the HRDI computing operation can provide an improved result over BT processes or methods.

Using the LRDI output from step 1 as input and true 2D lines as targets, a DL model can be trained for interpolation. However, such a DL model may have been proven to be extremely difficult to converge, when true 2D lines are very sparse (e.g., line spacing >5 km). To augment the amount of the training labels, a deterministic interpolation computing operation (e.g., HRDI computing operation) may be used to generate pseudo labels at selected trace locations at step 2. Compared to LRDI computing operations, HRDI computing operations use different rules that select source traces to generate the interpolated traces, in a layer-by-layer fashion. Specifically, instead of keeping all source traces within a search radius, a trace closest to the target trace location within each 2D line may be selected.

Moreover, for each trace segment between two interpreted horizons, the interpolation source segments may come from different traces. Such a procedure greatly improves the sharpness or resolution of the resultant data while also reducing the stretch-and-squeeze artifact caused by potentially large layer thickness differences between source and target locations, which can be quite severe in structurally complex subsurface regions. If the HRDI computing operation is performed over an entire 3D volume as shown in FIGS. 6G and 6H, the resulting 3D volume will have much sharper image than LRDI but with some interpolation artifacts, such as directional footprints, pattern blending, and conflicting dips, which will be mitigated in step 3. Specifically, FIG. 6G shows an exemplary vertical section data 600g of an HRDI-based interpolation result after step 2 while FIG. 6H shows a final pseudo-3D result 600h after step 3. It is appreciated that the HRDI result may provide a realistic seismic image, but with interpolation artifacts such as conflict dipping layers. The final pseudo-3D result further improves the consistency of the image, and mitigates against the artifacts observed in the HRDI result.

### Step 3

This step can include a TPDLI process which can be correlated or otherwise mapped to a machine learning interpolation method. However, unlike the random datapoint selections associated with some machine learning (ML) interpolation methods, the disclosed methods and systems enable selection of training data for the first round of ML training of the disclosed proxy model based on the consistency between the LRDI and HRDI results.

In step 3, two DL training and prediction passes along orthogonal directions may be performed. The final interpolation results are depicted in FIGS. 6H and 6J. In particular, FIG. 6I shows exemplary depth slices 600i of an HRDI-based interpolation result after step 2 while FIG. 6J shows an exemplary final pseudo-3D result 600j after step 3. Significantly reduced artifacts can be observed in at least FIG. 6J such that more natural seismic reflectors in the final pseudo-3D over the HRDI intermediate result can be achieved.

During the first pass, the DL model can be trained along an inline direction with the LRDI result as input and HRDI result at select trace locations as labels. A random selection of at least 3% of HRDI traces as pseudo labels can be implemented to limit trace locations where the HRDI and LRDI results share a high correlation. Such a selection scheme can ensure a successful DL model convergence, while also giving the DL model enough freedom and space to resolve artifacts between the pseudo label traces in accordance with the input LRDI. In the second pass, the first pass prediction is used as input, and the true 2D lines are used as labels during the training process. The final prediction is nicely converged to true datapoints at 2D line locations, while also providing excellent consistency in transition areas between 2D lines.

### Resource Site

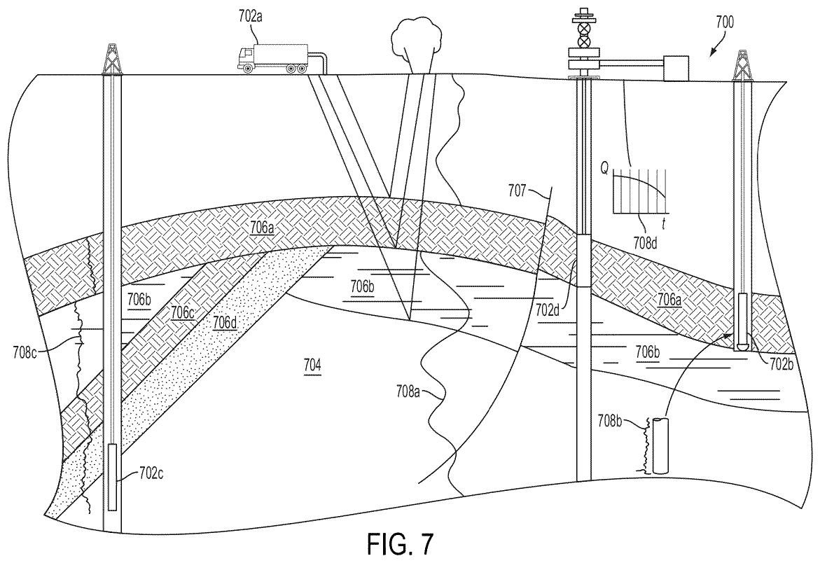

FIG. 7 shows a cross-sectional view of a resource site 700 for which the process of FIG. 6A may be executed. While the illustrated resource site 700 represents a subterranean formation, the resource site, according to some embodiments, may be below water bodies such as oceans, seas, lakes, ponds, wetlands, rivers, or other marine environments.

According to one embodiment, various measurement tools capable of sensing one or more resource site data such as seismic two-way travel time, density, resistivity, production rate, etc., of a subterranean formation and/or geological formations may be provided at the resource site. As an example, wireline tools may be used to obtain measurement information related to geological attributes (e.g., geological attributes of a wellbore and/or reservoir) including geophysical and/or chemical information. For example, the chemical information may include chemical information associated with the subsurface and/or chemical information associated with the surface/above ground areas of the resource site 700.

In some embodiments, various sensors may be located at various locations around the resource site 700 to monitor and collect data and/or core samples for executing the process of FIG. 9.

Part, or all, of the resource site 700 may be on land, on water, or below water. In addition, while a resource site 700 is depicted, the technology described herein may be used with any combination of one or more resource sites (e.g., multiple oil fields or multiple wellsites, one or more saline aquifers, one or more depleted oil/gas fields, etc.), one or more processing facilities, etc. As can be seen in FIG. 7, the resource site 700 may have data acquisition tools 702a, 702b, 702c, and 702d positioned at various locations within the resource site 700. The subterranean structure 704 may have a plurality of geological formations 706a-706d. As shown, this structure may have several formations or layers, including a shale layer 706a, a carbonate layer 706b, a shale layer 706c, and a sand layer 706d. A fault 707 may extend through the shale layer 706a and the carbonate layer 706b. The data acquisition tools, for example, may be adapted to take measurements and detect geophysical and/or chemical characteristics of the various formations shown.

While a specific subterranean formation with specific geological structures is depicted, it is appreciated that the resource site 700 may contain a variety of geological structures and/or formations, sometimes having extreme complexity. In some locations of a given geological structure, for example below a water line (e.g., aquifer) relative to the given geological structure, fluid may occupy pore spaces of the formations. Each of the measurement devices may be used to measure properties of the formations and/or other geological features. While each data acquisition tool is shown as being in specific locations in FIG. 7, it is appreciated that one or more types of measurement may be taken at one or more locations across one or more sources of the resource site 700 or other locations for comparison and/or analysis.

The data collected from various sources at the resource site 700 may be processed and/or evaluated and/or used as training data, and or used to generate high resolution result sets for characterizing a resource at the resource site, and/or used for generating resource models, etc. In one embodiment, the core sample data and/or data collected by a set of sensors at the resource site may include data associated with the number of wells of a first reservoir or second reservoir at the resource site, data associated with the number of grid cells of the first or second reservoir, data associated with the average permeability of the first or second reservoir, data associated with the production duration history (e.g., number of years of production) of the first reservoir or second, etc.

Data acquisition tool 702a is illustrated as a measurement truck, which may include devices or sensors that take measurements of the subsurface through sound vibrations such as, but not limited to, seismic measurements. Drilling tool 702b may include a downhole sensor adapted to perform logging while drilling (LWD) data collection. The wireline tool 702c may include a downhole sensor deployed in a wellbore or borehole. Production tool 702d may be deployed from a production unit or Christmas tree into a completed wellbore. Examples of resource site data that may be measured include weight on bit, torque on bit, subterranean pressures (e.g., underground fluid pressure), temperatures, flow rates, compositions, rotary speed, particle count, voltages, currents, and/or other parameters of operations as further discussed below.

Sensors may be positioned about the resource site to collect data relating to various resource site operations, such as sensors deployed by the data acquisition tools 702. The sensor may include any type of sensor such as a metrology sensor (e.g., temperature, humidity), an automation enabling sensor, an operational sensor (e.g., pressure sensor, H₂S sensor, thermometer, depth, tension), evaluation sensors, which can be used for acquiring data regarding the formation, wellbore, formation fluid/gas, wellbore fluid, gas/oil/water included in the formation/wellbore fluid, or any other suitable sensor. For example, the sensors may include accelerometers, flow rate sensors, pressure transducers, electromagnetic sensors, acoustic sensors, temperature sensors, chemical agent detection sensors, nuclear sensor, and/or any additional suitable sensors.

In one embodiment, the data captured by the one or sensors may be used to characterize, or otherwise generate one or more parameter values for a high-resolution result set used to, for example, label or configure a machine learning (ML) engine, a resource model as the case may require. In other embodiments, test data or synthetic data may also be used in developing the ML engine or resource model (e.g., a subsurface model) via one or more parameterization/labeling operations such as those discussed in association with FIG. 9.

Evaluation sensors may be featured in downhole tools such as tools 702b-702d and may include for instance electromagnetic, acoustic, nuclear, and optic sensors. Examples of tools including evaluation sensors that can be used in the framework of the current method include electromagnetic tools including imaging sensors such as FMI™ or QuantaGeo™ (mark of SLB, Houston, TX); induction sensors such as Rt Scanner™ (mark of SLB, Houston, TX), multifrequency dielectric dispersion sensor such as Dielectric Scanner™ (mark of SLB, Houston, TX); acoustic tools including sonic sensors, such as Sonic Scanner™ (mark of SLB, Houston, TX) or ultrasonic sensors, such as pulse-echo sensor as in UBI™ or PowerEcho™ (marks of SLB, Houston, TX) or flexural sensors PowerFlex™ (mark of SLB, Houston, TX); nuclear sensors such as Litho Scanner™ (mark of SLB, Houston, TX) or nuclear magnetic resonance sensors; fluid sampling tools including fluid analysis sensors such as InSitu Fluid Analyzer™ (mark of SLB, Houston, TX); distributed sensors including fiber optic. Such evaluation sensors may be used in particular for evaluating the formation in which the well is formed (i.e., determining petrophysical or geological properties of the formation), for verifying the integrity of the well (such as casing or cement properties) and/or analyzing the produced fluid (flow, type of fluid, etc.).

As shown, data acquisition tools 702a-702d may generate data plots or measurements 708a-708d, respectively. These data plots are depicted within the resource site 700 to demonstrate that data generated by some of the operations executed at the resource site 700.

Data plots 708a-708c are examples of static data plots that may be generated by data acquisition tools 702a-702c, respectively. However, it is herein contemplated that data plots 708a-708c may also be data plots that may be generated and updated in real time. These measurements may be analyzed to better define properties of the formation(s) and/or determine the accuracy of the measurements and/or check for and compensate for measurement errors. The plots of each of the respective measurements may be aligned and/or scaled for comparison and verification purposes. In some embodiments, base data associated with the plots may be incorporated into site planning, modeling a test at the resource site 700. The respective measurements that can be taken may be any of the above.

Other data may also be collected, such as historical data of the resource site 700 and/or sites similar to the resource site 700, user inputs, information (e.g., economic information) associated with the resource site 700 and/or sites similar to the resource site 700, and/or other measurement data and other parameters of interest. Similar measurements may also be used to measure changes in formation aspects over time.

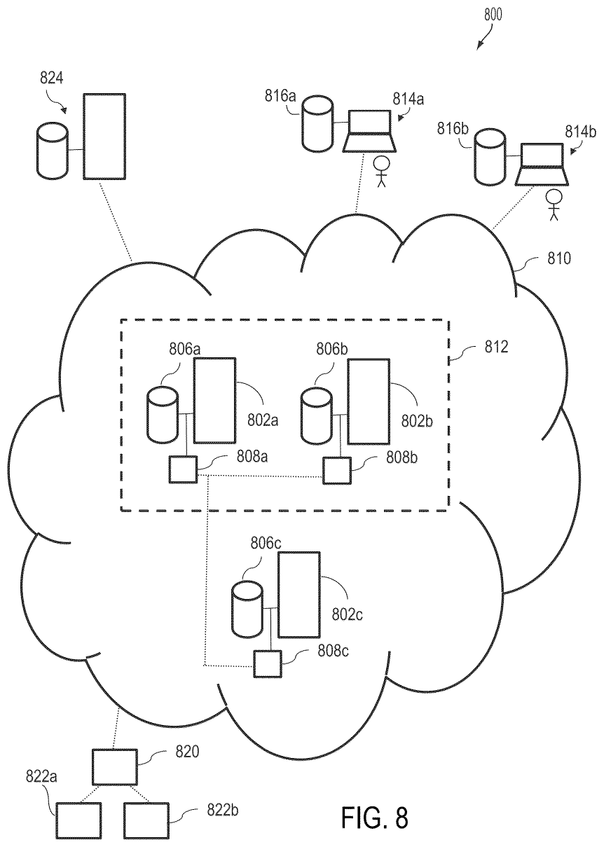

Computer facilities such as those discussed in association with FIG. 8 may be positioned at various locations about the resource site 700 (e.g., a surface unit) and/or at remote locations. A surface unit (e.g., one or more terminals 820) may be used to communicate with the onsite tools and/or offsite operations, as well as with other surface or downhole sensors. The surface unit may be capable of sending commands to the oil field equipment/systems, and receiving data therefrom. The surface unit may also collect data generated during production operations and can produce output data, which may be stored or transmitted for further processing.

The data collected by sensors may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis or for modeling purposes to optimize production processes at the resource site 700. In one embodiment, the data is stored in separate databases, or combined into a single database.

### Network System

FIG. 8 shows a high-level networked system diagram 800 illustrating a communicative coupling of devices or systems associated with the resource site 700 as described in FIG. 7. The system shown in the figure may include a set of processors 802a, 802b, and 802c for executing one or more processes discussed herein. The set of processors 802 may be electrically coupled to one or more servers (e.g., computing systems) including memory 806a, 806b, and 806c that may store for example, program data, databases, and other forms of data. Each server of the one or more servers may also include one or more communication devices 808a, 808b, and 808c. The set of servers may provide a cloud-computing platform 810. In one embodiment, the set of servers includes different computing devices that are situated in different locations and may be scalable based on the needs and workflows associated with the resource site 700. The communication devices of each server may enable the servers to communicate with each other through a local or global network such as an Internet network. In some embodiments, the servers may be arranged as a town 812, which may provide a private or local cloud service for users. A town may be advantageous in remote locations with poor connectivity. Additionally, a town may be beneficial in scenarios with large networks where security may be of concern. A town in such large network embodiments can facilitate implementation of a private network within such large networks. The town may interface with other towns or a larger cloud network, which may also communicate over public communication links. Note that cloud-computing platform 810 may include a private network and/or portions of public networks. In some cases, a cloud-computing platform 810 may include remote storage and/or other application processing capabilities.

The system of FIG. 8 may also include one or more user terminals 814a and 814b each including at least a processor to execute programs, a memory (e.g., 816a and 816b) for storing data, a communication device and one or more user interfaces and devices that enable the user to receive, view, and transmit information. In one embodiment, the user terminals 814a and 814b is a computing system having interfaces and devices including keyboards, touchscreens, display screens, speakers, microphones, a mouse, styluses, etc. The user terminals 814 may be communicatively coupled to the one or more servers of the cloud-computing platform 810. The user terminals 814 may be client terminals or expert terminals, enabling collaboration between clients and experts through the system of FIG. 8.

The system of FIG. 8 may also include at least one or more resource sites 700 having, for example, a set of terminals 820, each including at least a processor, a memory, and a communication device for communicating with other devices communicatively coupled to the cloud-computing platform 810. The resource site 700 may also have a set of sensors (e.g., one or more sensors described in association with FIG. 7) or sensor interfaces 822a and 822b communicatively coupled to the set of terminals 820 and/or directly coupled to the cloud-computing platform 810. In some embodiments, data collected by the set of sensors/sensor interfaces 822a and 822b may be processed to generate a one or more resource models (e.g., reservoir models) or one or more resolved data sets used to generate the resource model which may be displayed on a user interface associated with the set of terminals 820, and/or displayed on user interfaces associated with the set of servers of the cloud computing platform 810, and/or displayed on user interfaces of the user terminals 814. Furthermore, various equipment/devices discussed in association with the resource site 700 may also be communicatively coupled to the set of terminals 820 and or communicatively coupled directly to the cloud-computing platform 810. The equipment and sensors may also include one or more communication device(s) that may communicate with the set of terminals 820 to receive orders/instructions locally and/or remotely from the resource site 700 and also send statuses/updates to other terminals such as the user terminals 814.

The system of FIG. 8 may also include one or more client servers 824 including a processor, memory, and communication device. For communication purposes, the client servers 824 may be communicatively coupled to the cloud-computing platform 810, and/or to the user terminals 814a and 814b, and/or to the set of terminals 820 at the resource site 700 and/or to sensors at the oil field, and/or to other equipment at the resource site 700.

A processor, as discussed with reference to the system of FIG. 8, may include a microprocessor, a graphical processing unit (GPU), a microcontroller, a processor module or subsystem, a programmable integrated circuit, a programmable gate array, or another control or computing device.

The memory/storage media discussed above in association with FIG. 8 can be implemented as one or more computer-readable or machine-readable storage media that are non-transitory. In some embodiments, storage media may be distributed within and/or across multiple internal and/or external enclosures of a computing system and/or additional computing systems. Storage media may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs), BluRays or any other type of optical media; or other types of storage devices. “Non-transitory” computer readable medium refers to the medium itself (i.e., tangible, not a signal) and not data storage persistency (e.g., RAM vs. ROM).

Note that instructions can be provided on one computer-readable or machine-readable storage medium, or alternatively, can be provided on multiple computer-readable or machine-readable storage media distributed in a large system having possibly plural nodes and/or non-transitory storage means. Such computer-readable or machine-readable storage medium or media is (are) considered to be part of an article (or article of manufacture). The storage medium or media can be located either in a computer system running the machine-readable instructions, or located at a remote site from which machine-readable instructions can be downloaded over a network for execution.

It is appreciated that the described system of FIG. 8 is an example that may have more or fewer components than shown, may combine additional components, and/or may have a different configuration or arrangement of the components. The various components shown may be implemented in hardware, software, or a combination of both, hardware, and software, including one or more data processing and/or application specific integrated circuits.

Further, the steps in FIG. 9 described below may be implemented by running one or more functional modules in an information processing apparatus such as general-purpose processors or application specific chips, such as ASICs, FPGAs, PLDs, GPUs or other appropriate devices associated with the system of FIG. 8. For example, the flowchart of FIG. 9 below may be executed using a data engine or a data processing module (e.g., computing module) stored in memory 806a, 806b, or 806c such that the data engine/data processing module includes instructions that are executed by the one or more processors such as processors 802a, 802b, or 802c as the case may be. The various modules of FIG. 8, combinations of these modules, and/or their combination with general hardware are included within the scope of protection of the disclosure. While one or more computing processors (e.g., processors 802a, 802b, or 802c) may be described as executing steps associated with, for example, FIG. 9, the one or more computing device processors may be associated with the cloud-based computing platform 810 and may be located at one location or distributed across multiple locations. In one embodiment, the one or more computing device processors may also be associated with other systems of FIG. 8 other than the cloud-computing platform 810.

In some embodiments, a computing system is provided that includes at least one processor, at least one memory, and one or more programs stored in the at least one memory, such that the programs include instructions, which when executed by the at least one processor, are configured to perform any method disclosed herein.

In some embodiments, a computer readable storage medium is provided, which has stored therein one or more programs, the one or more programs including instructions, which when executed by a processor, cause the processor to perform any method disclosed herein. In some embodiments, a computing system is provided that includes at least one processor, at least one memory, and one or more programs stored in the at least one memory for performing any method disclosed herein. In some embodiments, an information processing apparatus for use in a computing system is provided for performing any method disclosed herein.

### Embodiments

This disclosure is directed to reconstructing 3-dimensional (3D) subsurface image volumes based on two-dimensional (2D) image measurements (e.g., seismic image measurements). According to one embodiment, a machine learning (ML) engine is used to construct a subsurface model indicating a 3D seismic volume based on 2D seismic lines. In particular, a proxy model indicating subsurface structural information of a subsurface region of interest may be provided as initial basis data or seed data for the ML engine. This proxy model can provide a priori information about subsurface structural data of a subsurface under consideration such that the a priori information of the subsurface is incorporated by the ML engine to automatically and directly train a subsurface model.

According to one embodiment, the disclosed method employs a multi-directional label-free learning strategy to enforce data coherence of the generated 3D volume in an efficient manner, resulting in a reliable subsurface structural reconstruction based on the subsurface model without suffering dimensionality data problems. In addition, the disclosed systems leverage a hybrid technique that jointly applies a deterministic and/or non-deterministic method associated with a proxy-based ML process. Whenever applicable, this hybrid approach can provide better resolution and clarity by incorporating inherent features from recorded data that is projected at randomly selected locations about a subsurface region of interest.

In some implementations, the ML engine creates a 3D volume using 2D seismic lines based on a deterministic process including a pseudo-gather construction technique. In particular, this construction technique may be based on applying a borrowing-neighbor directional search and vertical dynamic position correction process (e.g., a borrowing trace (BT) process) to the 2D seismic lines. In such a process, each subsurface location of interest is diversity summed based on a differential inverse distance between a desired location and collected locations (e.g., locations subsurface locations of interest) relative to each 2D seismic line. In some instances, the 2D seismic line is limited by a defined maximum acceptance distance, thereby resulting in a BT 3D volume that effectively preserves 2D resolution data associated with the 2D seismic lines. According to some embodiments, the generated BT 3D volume lacks blending artifacts that are removed or otherwise minimized or eliminated using the disclosed hybrid process. It is appreciated that the borrowing trace process uses 2D seismic images to construct a 3D seismic volume that may have blending artifacts. Because of these blending artifacts, the 3D seismic volume generated may require further computational editing or revisions prior to generating the final 3D seismic volume. It is appreciated that the ML engine beneficially facilitates removing the blending artifacts in the BT created volume. To do so, a small portion of BT generated traces associated with the BT volume is used to augment training of the subsurface model by the ML engine resulting in a first ML trained subsurface model. The ML trained subsurface model (e.g., 3D seismic volume) is much cleaner than the original BT created volume. In particular, the BT created volume creates the initial version of the subsurface volume, which is then used by ML engine to create the improved final version of the volume (e.g., the ML trained volume).

As part of generating the final version of the 3D seismic volume, a small set of traces in the BT created volume is randomly selected to augment a proxy model associated with a subsurface region of interest. For example, 2-3% of BT volume traces may be used for such augmentations. These traces can facilitate model reinforcements that bridge big gaps between sparse 2D seismic lines. In particular, the disclosed ML engine is configured to generate a plurality of content data based on the disclosed proxy volume. Thus, the disclosed proxy-based ML process can effectively suppress blending artifacts in BT results because it beneficially maintains signals that are more aligned with the disclosed proxy volume thereby ensuring that said signals are preserved and propagated into the final output volume (e.g., 3D volume) that is generated using the disclosed techniques.

FIG. 9 shows an exemplary hybrid data flow 900 associated with generating subsurface volume data using one or more ML engines. As can be seen in the figure, the ML engine 906a may receive proxy volume data 902 associated with a subsurface at a resource site as well as randomly selected borrowing trace (BT) result traces 904. According to one embodiment, a plurality of BT traces may be generated for the proxy volume data 902 such that the BT result traces 904 are selected from the plurality of BT traces generated for the proxy volume data 902. It is appreciated that the proxy volume data 902 can be generated using legacy data associated with a subsurface of interest at the resource site and/or synthetically generated data associated with the subsurface of interest at the resource site.

According to one embodiment, the randomly selected BT result traces 904 can be automatically determined for the proxy volume data 902 using, for example, data approximation techniques or data computations based the proxy model using a BT process. It is appreciated that the BT traces indicate vertical datapoint approximations of a plurality of vertical locations projected, based on the proxy volume data 902, from a surface location of the region of interest to a subsurface location within the region of interest for the subsurface of the resource site. For example, the vertical locations may represent an inline direction or a downward approximation of vertical locations in the subsurface that are directionally and/or agnostically and/or randomly selected for the region of interest within the subsurface of the resource site associated with the proxy volume data 902. According to one embodiment, the randomly selected BT result traces 904 may be based on the proxy volume data 902 such that the proxy volume data may be determined based on: legacy data associated with the region of interest at the resource site; a first set or a second set of sensor measurements (e.g., well log measurements) associated with the region of interest; horizon interpretation data associated with a first region at the resource site; horizon interpretation data associated with a second region at the resource site or a third region different from the first region and second region at the resource site or from another resource site such that the proxy volume data 902 is substantially similar to, or minimally distinct from the proxy volume data of the second region or third region.

At a first stage of the hybrid data flow, the ML engine 906a may generate an inline ML volume based on applying, in an inline direction (e.g., vertical direction), the randomly selected BT result traces 904 to the proxy volume data 902 and thereby generate first subsurface volume data 908 (e.g., inline volume). In particular, the first subsurface volume data 908 indicates an impact of interacting the randomly selected BT result traces 904 to the proxy volume data 902.

The second ML stage includes leveraging the same ML engine 906a and/or a different ML engine 906b to process the first subsurface volume data 908 in a crossline or horizontal direction based on 2D trace data 910 (e.g., derived from sensor measurements for one or more regions of interest at the resource site associated with the proxy volume data 902. In particular, the first or second ML engines 906a and 906b may apply the 2D line trace data 910 to the first subsurface volume data 908 in the crossline direction (e.g., horizontal direction) and thereby generate the second subsurface volume data 912. In some cases, the second subsurface volume data 912 indicates a final seismic image of the subsurface of the resource with no blending artifacts included therein, or little to no blending artifacts included therein.

According to one embodiment, the 2D trace data 910 may be based on actual sensor measurements (e.g., well log measurements) from a plurality of sensors (e.g., seismic sensors) that sparsely located (e.g., between 1 km-2 km, or between 1 km-3 km, or between 1 km-4 km, or between 1 km-5 km) relative to each other in a geometrically determined regional grid (e.g., square grid, circular grid, rectangular grid, triangular grid, or a combination of regional grids) included in, or associated with the proxy volume data 902. According to some embodiments, the 2D trace data may include data derived from sensor measurements (e.g., seismic sensor measurements) synchronously or asynchronously acquired using: a first set of sparsely spaced (e.g., between 1 km-2 km, or between 1 km-3 km, or between 1 km-4 km, or between 1 km-5 km) sensors deployed at a first region of interest at the resource site at a first time; and/or a second set of sparsely spaced sensors deployed at a second region of interest at the resource site at a second time; and/or a third set of sparsely spaced sensors deployed at a third region of interest at the resource site at a third time; and/or a fourth set of sparsely spaced sensors deployed at a third region of interest at the resource site at a fourth time.

In other embodiments, a plurality of 2D trace data 910 may be dynamically applied to the first subsurface volume data 908 to generate the second subsurface volume data 912 and thereby minimize or eliminate blending artifacts that distort or otherwise corrupt the second subsurface volume data 912. According to one embodiment, the second subsurface volume data 912 can be beneficially indicate: upstream domain data associated with exploring and producing energy; midstream domain data associated with transporting and storing energy; and downstream domain data associated with refining energy. In particular, the data included in the second subsurface volume data 912 can be advantageously used for equipment placement operations at the resource site by determining optimal locations, based on subsurface structures, to place energy extraction equipment such as pumps (e.g., oil or gas pumps), conveyor systems (e.g., tubings or piping, etc.) to place at the resource site. Also, the second subsurface volume data 912 can facilitate surgically determining a subsurface resource at the resource site.

It is appreciated that the disclosed process beneficially enables the use of 2D sensor measurements (e.g., 2D trace data 910) derived from substantially sparse sensors (e.g., seismic sensors, wellbore sensors, etc.) to generate 3D volume data of a subsurface based on proxy volume data. This beneficially leverages image data of a lower dimension (e.g., 2D trace data) in combination with a determined proxy volume to generate image data of a higher dimension (e.g., 3D volume data or the subsurface volume data 908 referenced above).

### Detailed Workflows

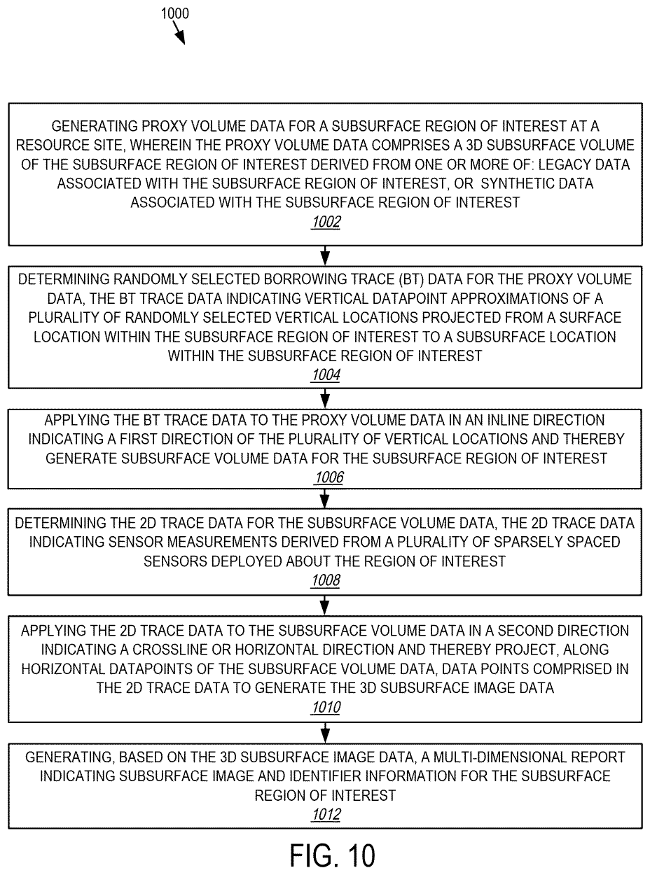

FIG. 10 shows an exemplary workflow 1000 for generating 3-dimensional (3D) subsurface image data based on 2-dimensional trace data. It is appreciated that a data engine stored in a memory device may cause a computer processor to execute the various stages of the workflow 1000. For example, the disclosed techniques may be implemented as a data engine of a computing platform associated with a geological software tool such that the data engine enables optimally generating 3-dimensional (3D) subsurface image data based on 2-dimensional trace data.

At block 1002, the data engine may generate proxy volume data for a subsurface region of interest at a resource site. According to one embodiment, the proxy volume data includes a 3D subsurface volume of the subsurface region of interest derived from one or more of: legacy data associated with the subsurface region of interest, or synthetic data associated with the subsurface region of interest.

Turning to block 1004, the data engine determines randomly selected borrowing trace (BT) data for the proxy volume data. The BT trace data can indicate vertical datapoint approximations of a plurality of randomly selected vertical locations projected from a surface location within the subsurface region of interest to a subsurface location within the subsurface region of interest.

At block 1006, the data engine applies the BT trace data to the proxy volume data in an inline direction indicating a first direction of the plurality of vertical locations and thereby generate subsurface volume data for the subsurface region of interest.

At block 1008, the data engine determines the 2D trace data for the subsurface volume data. For example, the 2D trace data can indicate sensor measurements derived from a plurality of sparsely spaced sensors deployed about the region of interest.

At block 1010, the data engine applies the 2D trace data to the subsurface volume data in a second direction and thereby project, along horizontal datapoints of the subsurface volume data, data points included in the 2D trace data to generate the 3D subsurface image data.

Moving on to block 1012, the data engine generates, based on the 3D subsurface image data, a multi-dimensional report indicating subsurface image and identifier information for the subsurface region of interest.

In other embodiments, a system and a computer program can include or execute the method described above. These and other implementations may each optionally include one or more of the following features.

Applying the 2D trace data to the subsurface volume data minimizes or eliminates blending artifacts included int the 2D trace data.

In some cases, the plurality of sparsely spaced sensors include seismic imaging sensors that capture 2-dimensional seismic images of the subsurface region of interest.

Moreover, the plurality of sparsely spaced sensors are spaced from each other by one of: about 1 km-2 km, or about 1 km-3 km, or about 1 km-4 km, or about 1 km-5 km.

According to some embodiments, a machine learning engine: applies the BT trace data to the proxy volume data in the inline direction, and applies the 2D trace data to the subsurface volume data in the crossline direction.

In addition, the machine learning engine referenced above can train a subsurface model associated with the resource site based on at least applying the BT trace data to the proxy volume data in an inline direction. This subsurface model can then be used in imaging applications associated with the subsurface of interest associated with the resource site or other subsurfaces that are similar to or distinct from the subsurface of interest referenced above in association with the resource site.

In some embodiments, the machine learning engine uses a convolutional neural network in training the subsurface model. In other embodiments, the machine learning uses a recurrent neural network and/or a deep neural network.

In some cases, the proxy volume data indicates a priori information about the subsurface region of interest.

In some embodiments, the BT data is derived from diversity summing, based on an inverse distance between a first set of subsurface locations associated with the proxy volume data relative to datapoints included in the 2D trace data.

According to some implementations, the report drives one or more energy development operations at the resource site.

It is appreciated that the BT data is generated based on a deterministic interpolation process. In one embodiment, the deterministic interpolation process is applied to the proxy volume to generate the subsurface volume data referenced above.

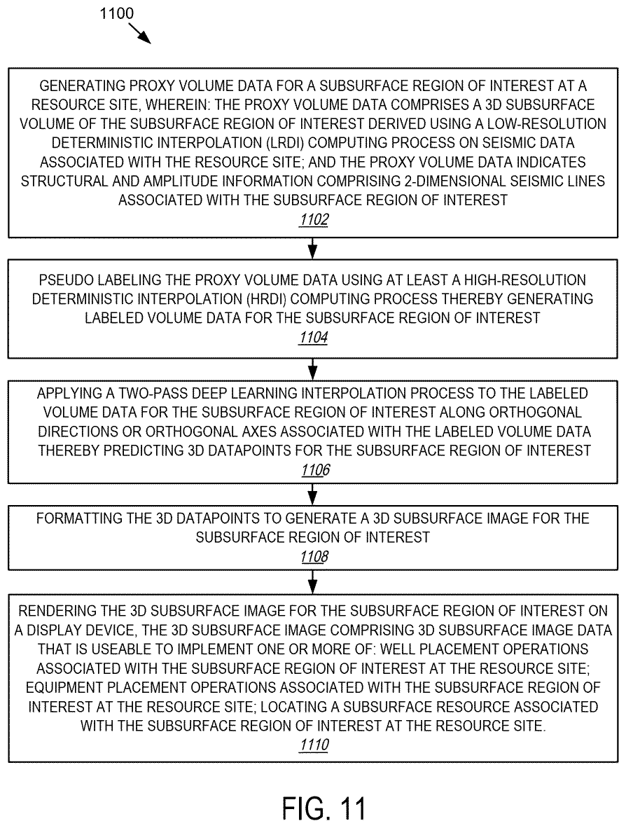

FIG. 11 shows an exemplary detailed workflow 1100 for methods, systems, and computer programs for generating 3-dimensional (3D) subsurface image data. It is appreciated that a data managing module or a data engine stored in a memory device may cause a computer processor to execute the various processing stages of the workflow 1000. For example, the disclosed techniques may be implemented as a data manager or signal processing engine within a geological software tool such that the data manager or signal processing engine enables generating 3D subsurface image data for energy development for a subsurface region of interest.

At block 1102, the data manager generates proxy volume data for a subsurface region of interest at a resource site. According to one embodiment, the proxy volume data includes a 3D subsurface volume of the subsurface region of interest derived using a low-resolution deterministic interpolation (LRDI) computing process on seismic data associated with the resource site. Furthermore, the proxy volume data can indicate structural and amplitude information including 2-dimensional seismic lines associated with the subsurface region of interest.

Turning to block 1104, the data manager conducts pseudo labeling the proxy volume data using at least a high-resolution deterministic interpolation (HRDI) computing process thereby generating labeled volume data for the subsurface region of interest.

At block 1106, the data manager applies a two-pass deep learning interpolation process to the labeled volume data for the subsurface region of interest along orthogonal directions or orthogonal axes associated with the labeled volume data thereby generating (e.g., predicting or estimating) 3D datapoints for the subsurface region of interest.

In addition, the data manager formats the 3D datapoints to generate a 3D subsurface image for the subsurface region of interest as indicated at block 1108.

At block 1110, the data manager renders the 3D subsurface image for the subsurface region of interest on a display device. According to one embodiment, the 3D subsurface image includes 3D subsurface image data that is useable to implement one or more energy development operations including at least one of: well placement operations associated with the subsurface region of interest at the resource site; equipment placement operations associated with the subsurface region of interest at the resource site; and locating a subsurface resource associated with the subsurface region of interest at the resource site.

In other embodiments, a system and a computer program can include or execute the method described above. These and other implementations may each optionally include one or more of the following features.

While any discussion of or citation to related art in this disclosure may or may not include some prior art references, such discussions are neither concessions nor acquiescence to the position that any given reference is prior art or analogous prior art.

The foregoing description, for purpose of explanation, has been described with reference to specific embodiments. However, the illustrative discussions above are not intended to be exhaustive or to limited to the precise forms disclosed. Many modifications and variations are possible in view of the above teachings. The embodiments were chosen and described in order to explain the principles and its practical applications, to thereby enable others skilled in the art to use various embodiments with various modifications as are suited to the particular use contemplated. It is appreciated that the term optimize/optimal and its variants (e.g., efficient or optimally) may simply indicate improving, rather than the ultimate form of ‘perfection’ or the like.

It will also be understood that, although the terms first, second, etc., may be used herein to describe various elements, these elements should not be limited by these terms. These terms are used to distinguish one element from another. For example, a first object or step could be termed a second object or step, and, similarly, a second object or step could be termed a first object or step, without departing from the scope. The first object or step, and the second object or step, are both objects or steps, respectively, but they are not to be considered the same object or step.

The terminology used in the description herein is for the purpose of describing particular embodiments and is not intended to be limiting. As used in the description and the appended claims, the singular forms “a,” “an” and “the” are intended to include the plural forms as well, unless the context clearly indicates otherwise. It will also be understood that the term “and/or” as used herein refers to and encompasses any possible combination of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context.

Those with skill in the art will appreciate that while some terms in this disclosure may refer to absolutes, e.g., all source receiver traces, each of a plurality of objects, etc., the methods and techniques disclosed herein may also be performed on fewer than all of a given thing, e.g., performed on one or more components and/or performed on one or more source receiver traces. Accordingly, in instances in the disclosure where an absolute is used, the disclosure may also be interpreted to be referring to a subset.

What is claimed is:

1. A method for generating three-dimensional (3D) subsurface image data, comprising:
generating proxy volume data for a subsurface region of interest at a resource site using a low-resolution deterministic interpolation (LRDI) computing process on seismic data associated with the resource site, wherein the proxy volume data comprises a 3D subsurface volume indicating structural and amplitude information from two-dimensional seismic lines associated with the subsurface region of interest;
pseudo labeling the proxy volume data using a high-resolution deterministic interpolation (HRDI) computing process to generate labeled volume data for the subsurface region of interest;
applying a two-pass deep learning interpolation process to the labeled volume data along orthogonal directions to predict 3D datapoints for the subsurface region of interest; and
formatting the 3D datapoints to generate a 3D subsurface image for the subsurface region of interest.

2. The method of claim 1, wherein the LRDI computing process comprises:
selecting N source traces from surrounding two-dimensional seismic lines for each interpolation target trace location;
structurally aligning the N source traces using interpreted seismic horizons; and
merging the N source traces into a single trace via inverse-distance weighted averaging.

3. The method of claim 2, wherein N is equal to sixteen source traces and the N source traces are within a defined search radius.

4. The method of claim 2, further comprising applying structural-guided smoothing configured to improve lateral continuity of the proxy volume data.

5. The method of claim 1, wherein the HRDI computing process comprises:
selecting one source trace closest to a target trace location within each two-dimensional seismic line; and
performing interpolation in a layer-by-layer fashion between interpreted seismic horizons.

6. The method of claim 5, wherein interpolation source segments for each trace segment between two interpreted horizons come from different source traces.

7. The method of claim 1, wherein the two-pass deep learning interpolation process comprises:
a first pass training a deep learning model along an inline direction using the proxy volume data as input and the labeled volume data at selected trace locations as labels, the first pass producing a first pass prediction; and
a second pass using the first pass prediction as input and true two-dimensional seismic lines as labels.

8. The method of claim 7, wherein the first pass randomly selects about 3% of source traces from the labeled volume data as pseudo labels at trace locations where the proxy volume data and the labeled volume data share a high correlation.

9. The method of claim 1, further comprising rendering the 3D subsurface image on a display device for implementing an energy development operation comprising at least one of a well placement operation, an equipment placement operation, or a locating of a subsurface resource.

10. The method of claim 9, wherein the energy development operation is performed at the resource site based on subsurface structural information indicated by the 3D subsurface image.

11. A system for generating three-dimensional (3D) subsurface image data, comprising:
a processor;
a memory coupled to the processor; and
instructions stored in the memory that, when executed by the processor, cause the system to:
generate proxy volume data for a subsurface region of interest at a resource site using a low-resolution deterministic interpolation (LRDI) computing process on seismic data, wherein the proxy volume data indicates structural and amplitude information from two-dimensional seismic lines;
perform pseudo labeling of the proxy volume data using a high-resolution deterministic interpolation (HRDI) computing process to generate labeled volume data;
apply a two-pass deep learning interpolation process to the labeled volume data along orthogonal directions to predict 3D datapoints; and
format the 3D datapoints to generate a 3D subsurface image.

12. The system of claim 11, wherein the instructions that cause the system to generate proxy volume data further cause the system to:
select N source traces from surrounding two-dimensional seismic lines of the two-dimensional seismic lines for each interpolation target trace location;
structurally align the N source traces using interpreted seismic horizons; and
merge the N source traces into a single trace via inverse-distance weighted averaging.

13. The system of claim 12, wherein N is equal to 16 source traces and the N source traces are within a defined search radius.

14. The system of claim 11, wherein the instructions that cause the system to apply the two-pass deep learning interpolation process further cause the system to:
perform a first pass by training a deep learning model along an inline direction using the proxy volume data as input and the labeled volume data at selected trace locations as labels, the first pass producing a first pass prediction; and
perform a second pass using the first pass prediction as input and true two-dimensional seismic lines as labels during training.

15. The system of claim 14, wherein the first pass randomly selects about 3% of traces from the labeled volume data as pseudo labels at trace locations where the proxy volume data and the labeled volume data share a high correlation.

16. A non-transitory computer-readable storage medium storing instructions that, when executed by a processor, cause the processor to perform operations comprising:
generating proxy volume data for a subsurface region of interest using a low-resolution deterministic interpolation (LRDI) computing process comprising selecting N source traces from surrounding two-dimensional seismic lines and merging the N source traces using inverse-distance weighted averaging after structural alignment;
pseudo labeling the proxy volume data using a high-resolution deterministic interpolation (HRDI) computing process comprising selecting source traces in a layer-by-layer fashion;
applying a two-pass deep learning interpolation process to labeled volume data derived from the pseudo labeling, wherein:
a first pass of the two-pass deep learning interpolation process trains a deep learning model along an inline direction using the proxy volume data as input and HRDI results as labels, the first pass generating a first pass prediction; and
a second pass two-pass deep learning interpolation process comprising using the first pass prediction as input with true two-dimensional seismic lines as labels, wherein the second pass predicts 3D datapoints; and
generating a 3D subsurface image from the predicted 3D datapoints.

17. The non-transitory computer-readable storage medium of claim 16, wherein N is equal to 16 source traces and the source traces are within a defined search radius.

18. The non-transitory computer-readable storage medium of claim 17, wherein the operations further comprise applying structural-guided smoothing to the proxy volume data.

19. The non-transitory computer-readable storage medium of claim 16, wherein the HRDI computing process selects one source trace closest to a target trace location within each two-dimensional seismic line, and wherein interpolation source segments for each trace segment between two interpreted horizons come from different source traces of the N source traces.

20. The non-transitory computer-readable storage medium of claim 16, wherein the first pass randomly selects about 3% of traces from the labeled volume data as pseudo labels including trace locations where the proxy volume data and the labeled volume data share a high correlation.
